(19) United States
(12) Patent Application Publication
(10) Pub. No.: US 2026/0288772 A1
(43) Pub. Date: Sep. 24, 2026

(54) SYSTEM

(71) Applicant: SoftBank Group Corp., Tokyo (JP)

(72) Inventor: Shingo KUSANO, Tokyo (JP)

(73) Assignee: SoftBank Group Corp., Tokyo (JP)

(21) Appl. No.: 19/568,858

(22) Filed: Mar. 17, 2026

(30) Foreign Application Priority Data
Mar. 19, 2025 (JP) 2025-045255

(51) Int. Cl. G06F 16/332; G06F 16/335

(52) U.S. Cl. CPC G06F 16/3322; G06F 16/337

(57) ABSTRACT

A system includes a processor that is configured to receive, by using a sensor device, information from a user regarding a child's behavior, interests, and activities, preprocess data and extract features from the received information by using a machine learning algorithm, and generate a prompt that instructs a generative artificial intelligence model to generate a report proposing play and educational activities suitable for the child based on an analysis result.

### CROSS-REFERENCE TO RELATED APPLICATION

This application is based on and claims priority under 35 USC 119 from Japanese Patent Application No. 2025-045255 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for supporting children's play and educational activities mainly rely on static questionnaires, generic recommendation rules, or simple profiling based on limited user input. Such systems have several problems. First, the systems often fail to accurately reflect the child's actual behavior, interests, and ongoing activities, because they do not continuously acquire rich, real-world information through sensor devices. Second, even when the systems receive behavioral information, the systems typically lack advanced preprocessing and feature extraction using machine learning, and thus cannot derive deep or nuanced child characteristics from unstructured data. Third, existing systems usually generate fixed recommendations and do not dynamically adapt the content to the emotional state of the user, which may reduce user acceptance and practical effectiveness of the proposed activities. Fourth, the systems rarely perform time-series analysis on past child data, and therefore cannot capture changes in the child's traits over time or provide longitudinal insights that support developmental tracking. As a result, it is difficult for users to obtain personalized, context-aware, and emotionally adapted reports suggesting play and educational activities that are truly suitable for an individual child.

### SUMMARY

In order to solve the above-described problems, a system according to one aspect of the invention comprises a processor configured to receive, by using a sensor device, information from a user regarding a child's behavior, interests, and activities; preprocess data and extract features from the received information by using a machine learning algorithm; and generate a prompt that instructs a generative artificial intelligence model to generate a report proposing play and educational activities suitable for the child based on an analysis result. In addition, the processor is configured to analyze voice data of the user to recognize an emotional state of the user by using a voice analysis technique, calculate an emotion parameter based on the emotional state, and adjust content of the generated report according to the emotion parameter and notify the adjusted report to the user, thereby adapting the report presentation and recommendations to the user's emotional condition. Furthermore, the processor is configured to access a past database and perform time-series analysis by comparing past data to extract characteristics of the child, so that the system can identify temporal changes in the child's traits and provide more accurate and developmentally informed suggestions. By integrating sensor-based data acquisition, machine learning-based feature extraction, generative AI prompting, emotion-aware report adjustment, and time-series analysis of historical data, the system enables generation and delivery of highly personalized, context-sensitive, and emotionally adaptive reports that propose play and educational activities tailored to each child.

The term “processor” refers to one or more hardware processing units, such as a central processing unit (CPU), a graphics processing unit (GPU), a digital signal processor (DSP), or any combination thereof, configured to execute instructions for implementing functions of the system.

The term “sensor device” refers to any hardware device capable of acquiring information related to a child or a user, including but not limited to microphones, cameras, motion sensors, wearable sensors, input terminals, or combinations thereof, and providing the acquired information to the processor.
The term “information regarding a child's behavior, interests, and activities” refers to data describing how a child acts, what the child likes or dislikes, and what the child is doing or engaging in, including but not limited to textual input, voice input, images, or sensor measurements reflecting such behavior, interests, and activities.
The term “preprocess data” refers to performing one or more operations on raw input data, such as cleaning, normalizing, transforming, segmenting, or encoding the data, to make the data suitable for further analysis by a machine learning algorithm.
The term “features” refers to numerical values, categorical indicators, or other structured representations derived from raw data that characterize aspects of a child's behavior, interests, or activities and are usable as inputs to analytical models or algorithms.
The term “machine learning algorithm” refers to a computational method or model, including but not limited to neural networks, decision trees, support vector machines, clustering algorithms, or ensemble methods, that is trained or configured to learn patterns from data and used to perform preprocessing, feature extraction, or analysis.
The term “analysis result” refers to information generated by applying a machine learning algorithm or other analytical method to preprocessed data and extracted features, the information including inferred characteristics such as strengths, weaknesses, preferences, tendencies, or developmental patterns of a child.
The term “prompt” refers to data, typically in a structured or natural language form, that specifies instructions, conditions, or context to be provided as input to a generative artificial intelligence model so as to control or guide generation of output content.
The term “generative artificial intelligence model” refers to a model configured to generate new content, including but not limited to text, images, or audio, in response to input data or a prompt, such as a large language model, a generative adversarial network, or a diffusion model.
The term “report” refers to a structured output document or data set generated by the generative artificial intelligence model, including explanatory text or other content that proposes or describes play and educational activities suitable for a particular child.
The term “play and educational activities suitable for the child” refers to recommended actions, games, exercises, lessons, or programs that align with the child's inferred characteristics, such as strengths, weaknesses, and interests, and are intended to support the child's development or learning.
The term “voice data” refers to audio signals or recordings that include speech or other vocal sounds produced by a user, which are acquired by a microphone or equivalent device and processed by the system.
The term “voice analysis technique” refers to a method or algorithm for processing voice data, including but not limited to speech recognition, prosody analysis, acoustic feature extraction, or emotion recognition, in order to derive information such as emotional state.
The term “emotional state of the user” refers to an affective condition of the user, such as happiness, sadness, anger, anxiety, or calmness, inferred from voice data or other signals by the system.
The term “emotion parameter” refers to a numerical value, label, vector, or set of values representing one or more aspects of the user's emotional state, derived from analysis of voice data or other input.
The term “past database” refers to a storage resource that holds previously collected data related to a child, including past observations, past reports, past features, or other historical records, which can be accessed by the processor for analysis.
The term “past data” refers to historical records stored in the past database, including prior information on a child's behavior, interests, activities, features, analysis results, or reports that have been accumulated over time.
The term “time-series analysis” refers to a method of analyzing data that is ordered in time, by comparing values at different time points to identify trends, patterns, changes, or temporal relationships in a child's characteristics.
The term “characteristics of the child” refers to inferred attributes of the child, including but not limited to cognitive abilities, behavioral tendencies, preferences, developmental progress, strengths, and weaknesses, which are derived from analysis of received information and past data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

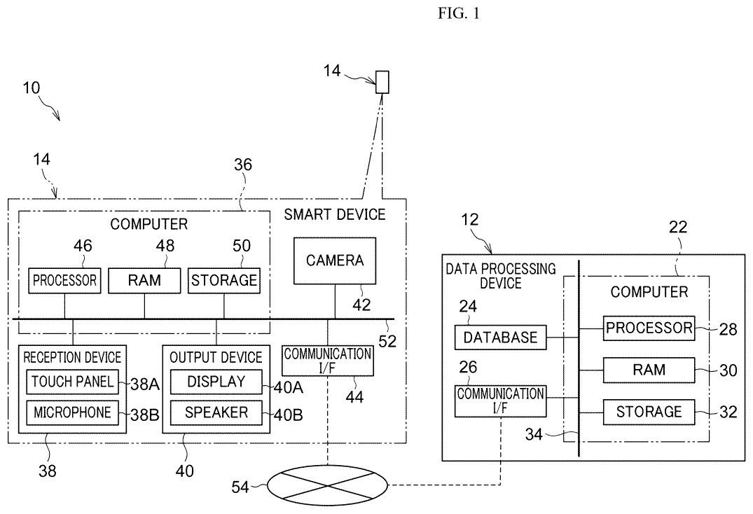

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

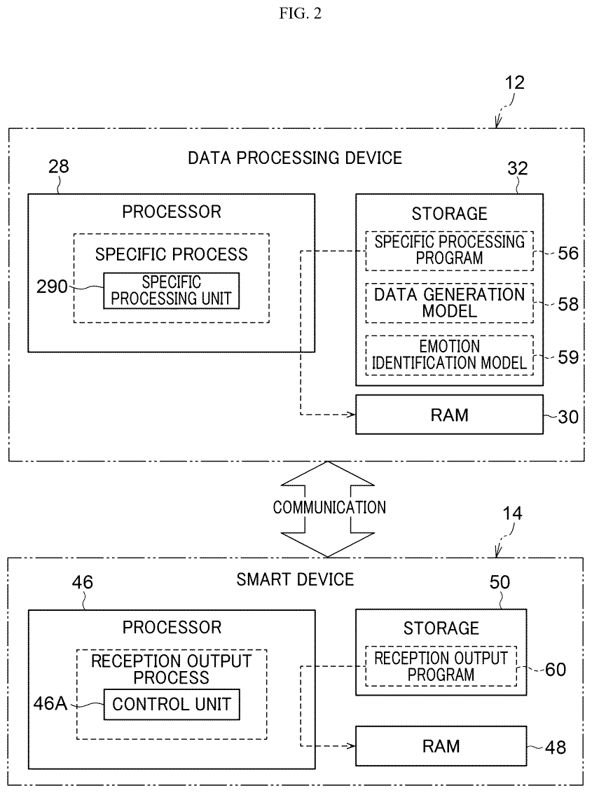

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional child activity recommendation systems generally rely on manually defined rule sets or shallow pattern matching to map a child's behavior description to suggested activities. Such systems suffer from several technical limitations. First, input data originating from user-operated terminals is typically handled as unstructured text without systematic preprocessing or feature extraction, which leads to inefficient utilization of computing resources and unreliable analysis results. Second, existing systems often apply machine learning models and text generation functions in a loosely coupled manner, without an integrated pipeline that converts intermediate analysis outputs into precisely conditioned prompts for a generative artificial intelligence model. As a result, the generated reports can be inconsistent, difficult to control, and poorly aligned with the inferred characteristics of the child. Third, conventional architectures rarely use feedback loops in which user evaluations and activity execution results are collected and used to adapt the underlying machine learning and recommendation models, thereby limiting the system's ability to improve analysis accuracy over time. Fourth, time-series aspects of child behavior are usually ignored or treated superficially, preventing the system from technically recognizing temporal patterns in interests and learning tendencies and from adjusting generated content based on such temporal analysis.

From a computer technology perspective, these limitations manifest as suboptimal data flow between terminals, servers, storage devices, and learning models, inefficient use of model outputs for downstream generative processing, and a lack of systematic mechanisms for online adaptation and temporal modeling. There is therefore a need for a technical solution that (i) structures and preprocesses descriptive child behavior data on the server in a consistent manner, (ii) integrates feature extraction and machine learning-based characteristic analysis with prompt generation for a generative artificial intelligence model, (iii) incorporates user feedback as machine-interpretable training data for continuous model refinement, and (iv) performs time-series analysis over stored descriptive and characteristic information to technically adjust both prompts and generated reports. Such a solution should improve the overall operation of the computer system itself, by providing a more efficient, accurate, and controllable pipeline for producing child-appropriate activity proposals.

The specific processing by the specific processing unit 290 of the data processing device 12 in Example 1 is realized by the following means.

The present invention provides a server comprising a processor and a storage device, the processor being configured to receive, via a communication network, descriptive information regarding behavior, interests, and activities of a child from an information processing terminal operated by a user, convert the descriptive information into a predetermined data structure, and store the converted descriptive information in the storage device; to execute a preprocessing pipeline on the stored descriptive information by using a character string processing program to perform at least normalization, segmentation, and removal of unnecessary terms, and to generate feature data by converting the preprocessed descriptive information into a numerical representation by using a natural language processing model; to analyze the feature data by using a machine learning model including at least one of a statistical learning model and a neural network model in order to calculate characteristic information indicating interest domains and learning tendencies of the child; to apply at least one of a rule set and a recommendation model to the characteristic information so as to select activity information representing play and educational activities suitable for the child, and to generate analysis result data including the activity information and the characteristic information; to execute a prompt generation process based on the analysis result data so as to construct a prompt sentence for input to a generative artificial intelligence model, the prompt sentence being described in a natural language and including instruction content based on the characteristic information and the activity information; to input the prompt sentence to the generative artificial intelligence model disposed externally or internally, acquire a response sentence from the generative artificial intelligence model as an analysis report, store the analysis report in the storage device, and format the analysis report as notification data that is transmittable to the information processing terminal; and to transmit the notification data to the information processing terminal and cause the analysis report to be displayed on the information processing terminal so as to present information for proposing the play or the educational activities suitable for the child to the user. This enables a technically integrated and computer-implemented pipeline in which raw descriptive input data from a user-operated terminal is systematically preprocessed, transformed into feature-level representations, analyzed to derive characteristic information, converted into a structured prompt sentence for a generative artificial intelligence model, and returned as a refined analysis report, thereby improving the efficiency, controllability, and accuracy of child activity proposal generation within the computer system.

The term “processor” refers to an electronic data processing unit, such as a central processing unit or a specialized computing circuit, that executes instructions of a program to perform arithmetic operations, logical operations, control operations, and data transfer operations.

The term “storage device” refers to a hardware component, such as a semiconductor memory, magnetic storage, or optical storage, that stores data, programs, and intermediate results in a non-transitory manner for use by a processor.
The term “communication network” refers to a wired or wireless communication infrastructure, including local area networks, wide area networks, and public networks, that enables data transmission between an information processing terminal and a server.
The term “information processing terminal” refers to an electronic computing apparatus operated by a user, such as a portable communication device, a tablet terminal, or a personal computer, that can input, transmit, receive, and display data through a communication network.
The term “user” refers to a human operator, such as a guardian or educator of a child, who interacts with the information processing terminal to input data and to receive generated reports and recommendations.
The term “child” refers to a human subject of analysis for whom behavior, interests, and activities are observed, recorded, and evaluated by the system.
The term “descriptive information” refers to text data or equivalent symbolic data that expresses, in natural language or structured form, observations about behavior, interests, and activities of a child.
The term “predetermined data structure” refers to a defined internal representation format, such as a record, object, or structured data element, in which descriptive information is organized by using predefined fields or attributes.
The term “character string processing program” refers to software configured to handle textual data, including functions for normalization, segmentation, tokenization, filtering, and other transformations applied to character strings.
The term “normalization” refers to a text preprocessing operation that converts input text into a standardized form, such as by unifying character sets, converting case, or applying consistent formatting rules.
The term “segmentation” refers to a text preprocessing operation that divides input text into smaller units, such as words, tokens, or sentences, suitable for subsequent analysis.
The term “removal of unnecessary terms” refers to a text preprocessing operation in which words or tokens that are predetermined as carrying little analytical value, such as stop words or noise symbols, are eliminated from the text.
The term “feature data” refers to a numerical representation of textual or symbolic input, such as a vector or matrix, that encodes linguistic or semantic characteristics suitable for processing by a machine learning model.
The term “natural language processing model” refers to a trained computational model designed to process natural language text, including models that perform tasks such as embedding generation, linguistic analysis, or semantic representation.
The term “machine learning model” refers to a trained computational model, including at least one of a statistical learning model and a neural network model, that infers patterns or relationships from input data to produce predicted values, classifications, or characteristic information.
The term “statistical learning model” refers to a model based on statistical methods, such as regression, probabilistic inference, or clustering, that is trained by using data samples to learn parameters for prediction or classification.
The term “neural network model” refers to a computational model composed of multiple interconnected processing units or layers that performs learning and inference by adjusting connection parameters based on training data.
The term “characteristic information” refers to data that represents inferred properties of a child, including at least interest domains and learning tendencies, calculated by processing feature data with a machine learning model.
The term “interest domains” refers to categories or topics toward which a child exhibits preference or curiosity, as identified from descriptive information and inferred by a learning model.
The term “learning tendencies” refers to patterns relating to how a child engages in learning, such as preferred content types, styles of interaction, or typical response behaviors, as derived from analytical processing.
The term “rule set” refers to a collection of predetermined logical conditions and corresponding actions that map characteristic information to activity information or control subsequent processing steps.
The term “recommendation model” refers to a computational model that, given characteristic information and optionally historical data, selects or ranks activities that are predicted to be suitable or beneficial for a child.
The term “activity information” refers to data representing proposed play or educational activities, including at least descriptors of the content, type, or difficulty of such activities.
The term “analysis result data” refers to structured data that includes at least characteristic information and activity information output from analytical processing steps.
The term “prompt generation process” refers to a series of operations that construct a natural-language instruction text, based on analysis result data, for input to a generative artificial intelligence model.
The term “prompt sentence” refers to a natural-language instruction sequence that specifies input conditions, constraints, or desired outputs to a generative artificial intelligence model.
The term “generative artificial intelligence model” refers to a trained computational model that, in response to an input prompt, generates new content, such as natural-language text, by probabilistic or learned sequence prediction.
The term “response sentence” refers to a natural-language text sequence output by a generative artificial intelligence model in response to a given prompt sentence.
The term “analysis report” refers to a document or text body generated at least in part from a response sentence, which explains characteristic information of a child and proposes corresponding play or educational activities.
The term “notification data” refers to data formatted for transmission to an information processing terminal, including at least an analysis report or an indicator thereof, and optionally metadata for presentation and access control.
The term “evaluation information” refers to data indicating a user's assessment of an analysis report or of proposed activities, including ratings, selections, or free-form comments. The term “activity execution result information” refers to data indicating whether and how proposed activities were executed by or with a child, including success status, degree of engagement, or observed outcomes.
The term “history data” refers to accumulated records of evaluation information, activity execution result information, or other time-stamped data related to child behavior and system outputs, stored in association with identifiers.
The term “training data” refers to data used to adjust parameters of a machine learning model or a recommendation model, including feature data, target labels, feedback-derived signals, and historical context.
The term “learning process” refers to computational procedures that update parameters of a machine learning model or recommendation model based on training data so as to improve prediction or recommendation performance.
The term “time-series analysis processing” refers to a computational technique applied to data indexed by time, configured to identify trends, periodicities, or change patterns over multiple time points.
The term “change patterns” refers to detectable temporal variations in interest domains or learning tendencies, such as increases, decreases, or shifts between categories over time.
The term “temporal analysis result” refers to data representing the outcome of time-series analysis processing, including identified change patterns and associated metrics, that can influence prompt generation or report content.
The term “external model” refers to a generative artificial intelligence model or other computational model that is deployed on a system or platform different from the server, and accessed via a communication interface.
The term “internal model” refers to a generative artificial intelligence model or other computational model that is deployed within the same server or computing environment as the processor executing the main processing flow.

In an embodiment, a server, a terminal, and a user cooperate to implement the claimed system. The server includes a processor, a main memory, a non-transitory storage device, a network interface, and, in some embodiments, an accelerator such as a graphics processing unit. The terminal includes a processor, a display, an input interface, a memory, and a network interface. The user operates the terminal to input descriptive information about a child and to view analysis reports and recommended activities.

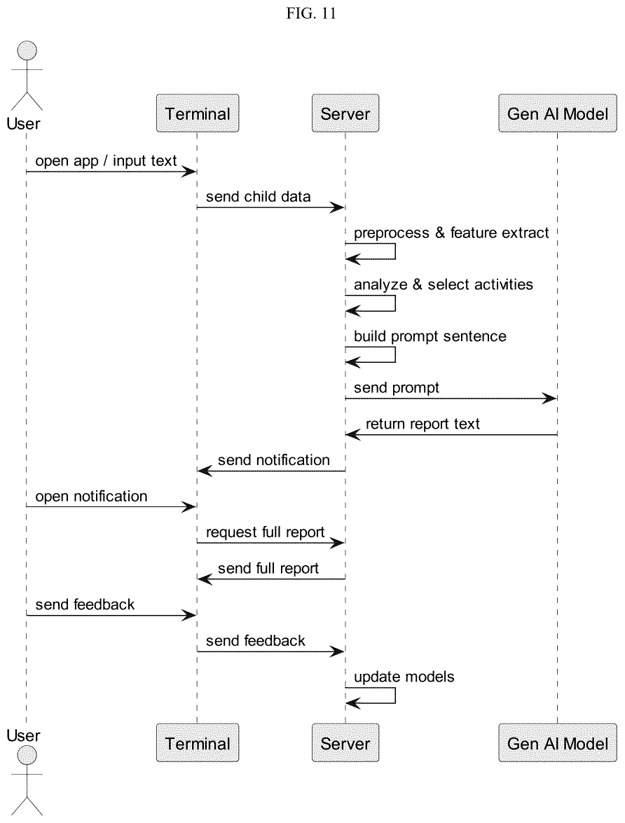

The server executes an operating system such as a generic server operating system and a group of application programs implementing the functional modules described below. The server stores, in the storage device, executable programs, trained model parameters, configuration data, and multiple data structures including at least a behavior log data structure, a feature data structure, a characteristic data structure, an activity data structure, a prompt data structure, and a report data structure.
The terminal executes an operating system such as a generic mobile or desktop operating system, and an application or a browser-based client program that displays user interfaces for inputting descriptive information and for receiving notifications and reports. The terminal uses a communication protocol such as HTTPS over TCP/IP to exchange data with the server via a wired or wireless communication network.
In an embodiment, the user uses the terminal to input descriptive information regarding behavior, interests, and activities of a child. The terminal structures this input into a record including at least a child identifier, a user identifier, a timestamp, and a text field containing descriptive information. The terminal sends the structured data as a request message to the server through the network interface.
The server receives the request message and stores the received descriptive information in the behavior log data structure in the storage device. The server uses a relational database management system or an equivalent data management system to manage the behavior log data. Each behavior log entry stores fields such as a log identifier, the child identifier, the user identifier, a timestamp, and the descriptive text.
The server performs text preprocessing on the descriptive text by executing a character string processing program. The server uses a natural language processing library such as a generic tokenization and normalization library to convert the raw text into a standardized format. The server performs normalization operations including at least conversion of characters to a common case, unification of numeral formats, and conversion of punctuation to canonical forms. The server performs segmentation operations including tokenization into word units or subword units based on a pre-defined vocabulary, and, in some embodiments, segmentation into sentence units.
The server removes unnecessary terms by comparing each token with a stop word list stored in the storage device. The stop word list includes function words and high-frequency tokens that have been determined by statistical analysis to contribute minimally to downstream classification accuracy. The server optionally applies lemmatization or stemming to reduce inflected forms to canonical base forms. These operations generate a cleaned token sequence that reduces noise and redundancy in the data.
The server converts the cleaned token sequence into feature data by using a natural language processing model. In an embodiment, the server uses a neural network embedding model configured as a multi-layer transformer encoder. The server loads model parameters from the storage device into memory and executes the model on the processor or the graphics processing unit. The server maps tokens to embedding vectors using a learned embedding matrix and propagates these vectors through multiple self-attention layers and feedforward layers. The output layer of the transformer encoder generates a fixed-dimensional vector representation of the descriptive information, which the server stores as feature data. This feature data is organized in a feature data structure indexed by the behavior log identifier.
The server analyzes the feature data using a machine learning model to compute characteristic information indicating interest domains and learning tendencies of the child. In an embodiment, the server employs a neural network model configured as a multi-layer perceptron that receives the feature vector and outputs a set of continuous scores associated with predefined interest categories and learning tendency categories. The server applies activation functions such as rectified linear units and uses a softmax or sigmoid function in the output layer to obtain normalized scores for each category.
During training, the server previously generated model parameters by executing a learning process on a training dataset. The server used a loss function such as cross-entropy loss or mean squared error, and updated model weights by a gradient-based optimization algorithm such as stochastic gradient descent or a variant thereof. The server optionally applied techniques such as batch normalization, dropout, and data augmentation (for example, synonym replacement or minor paraphrasing of descriptive texts) to improve generalization and reduce overfitting. As a result, the trained model is configured to map feature data to characteristic information with improved accuracy and robustness.
The server interprets the model output as characteristic information and stores this information in a characteristic data structure. The characteristic data structure associates, for each child identifier and timestamp, a vector of interest domain scores and learning tendency scores. By storing the characteristic information in a structured form, the server enables efficient retrieval and temporal analysis in later stages.
The server generates activity information by applying at least one of a rule set and a recommendation model to the characteristic information. In an embodiment, the server uses a rule set that specifies thresholds for interest domain scores and associates each threshold crossing with one or more candidate activities. For example, a rule may specify that when a score for a domain corresponding to prehistoric animals exceeds a first threshold, the server selects activities such as visiting an exhibition, reading introductory books, or performing themed crafts. The server also uses a recommendation model that receives the characteristic information and, optionally, historical feedback as input and outputs a ranking score for each candidate activity stored in an activity catalog in the storage device. The recommendation model may be implemented as a matrix factorization model, a factorization machine, or a neural network-based ranking model.
The server combines the rule-based selections and the recommendation model rankings to form activity information. The server can, for example, select a subset of candidate activities that satisfy both rule-based criteria and ranking thresholds. The server stores the selected activity information in the activity data structure, which includes fields such as an activity identifier, an activity type, a difficulty level, an estimated duration, and tags indicating related interest domains.
The server then constructs analysis result data that includes at least the characteristic information and the activity information for a specific child. The analysis result data is stored in an intermediate data structure that organizes the information by child identifier, time, and analysis session. The server uses this analysis result data as the basis for generating a prompt sentence for a generative artificial intelligence model.
The server executes a prompt generation process. In this process, the server loads a prompt template from the storage device. The prompt template is a natural-language text pattern containing placeholders for characteristic information and activity information. The server fills these placeholders with the computed scores, category names, and activity descriptions to construct a prompt sentence.
For example, the server generates a prompt sentence such as:
“You are an educational advisor. A child shows strong interest in dinosaurs (score 0.93) and high interest in science (score 0.81). Using this information, write a concise, parent-friendly report that (1) summarizes the child's interests and strengths in one paragraph, and (2) recommends three concrete activities, such as museum visits, books, or home projects, related to dinosaurs and basic science. Output in English.”
In another example, the server generates a prompt sentence such as:
“Analyze the following child description and create a parent-friendly report. The child has a strong interest in dinosaurs (score 0.93) and science (score 0.81). Summarize the child's interests and strengths in two paragraphs and recommend three specific activities related to dinosaurs and basic science. Child description: ‘My child spends a lot of time watching dinosaur videos and asking why dinosaurs disappeared.’”
The server thereby uses the analysis result data to condition the prompt sentence in a structured and reproducible manner. This structured prompt generation improves the technical behavior of the generative artificial intelligence model by providing more precise conditioning inputs compared to free-form prompts, leading to more stable and controllable outputs.
The server inputs the generated prompt sentence to a generative artificial intelligence model.
In an embodiment, the server accesses an external generative model via an application programming interface over the communication network. In another embodiment, the server executes an internal generative model stored on the storage device and loaded into memory.
The generative model is implemented as an autoregressive neural network, such as a transformer-based language model, that predicts a next token conditional on previous tokens.
The server passes the prompt sentence as an input token sequence, and the model outputs a response sentence by sampling from the predicted token distribution until a stop condition is met.
The server controls generation parameters such as maximum length, temperature, and top-k or nucleus sampling thresholds to balance diversity and determinism in the generated text.
The server receives the response sentence as generated text and stores it in the report data structure as an analysis report. The server may optionally perform post-processing including filtering of prohibited content, truncation to enforce length limits, and insertion of formatting markers for display.
The server converts the analysis report into notification data suitable for transmission to the terminal. The notification data includes at least an identifier of the analysis session, a summary of the report, and a pointer to the full report content. The server sends a notification message through a push notification service, email, or an in-app messaging channel.
The terminal receives the notification data and presents a notification on the display. When the user operates the terminal to open the notification, the terminal requests the full analysis report from the server. The server sends the full report content, and the terminal renders the report on the display by using a graphical user interface. The user thereby views a detailed explanation of the child's characteristics and specific recommended activities.
In an embodiment, the user uses the terminal to input evaluation information regarding the analysis report or activity execution result information. For example, the user may indicate that a specific recommended activity was performed and provide a rating or a short comment about the child's reaction. The terminal packages this feedback information together with identifiers for the child, the analysis session, and the activities, and sends the package to the server.
The server receives the feedback information and stores it as history data in the storage device, associated with the corresponding child and activities. The server uses this history data to update training data for the machine learning model and the recommendation model.
The server constructs supervised learning examples where the characteristic information and proposed activity identifiers form input features, and the feedback signals form target labels.
The server re-trains or fine-tunes the models by using the same or a related loss function and optimization method as used during initial training. The server may schedule such updates periodically or based on an amount of newly accumulated feedback. By incorporating feedback in this way, the server incrementally improves the accuracy of characteristic estimation and activity selection. This adaptive adjustment goes beyond static rule-based systems and yields a technical improvement in model performance over time.
In a further embodiment, the server performs time-series analysis on the descriptive information and the characteristic information stored for multiple time points. The server retrieves, for a given child, a sequence of characteristic vectors corresponding to different dates. The server applies a time-series analysis method, such as a recurrent neural network, a temporal convolution network, or a statistical model such as an autoregressive integrated moving average model, to detect trends and shifts in interest domains and learning tendencies.
The server calculates change patterns indicating, for example, gradual increases of interest in scientific topics, temporary spikes in interest in particular themes, or shifts from one learning style to another. The server stores this temporal analysis result in an additional data structure that records trend values and change events. The server uses this temporal analysis result to adjust subsequent prompt sentences and analysis reports. For example, when a trend analysis indicates that a specific interest has been stable for a prolonged period, the server modifies the prompt sentence to request a more advanced set of activities. When a recent shift is detected, the server modifies the prompt to emphasize the new interest and to suggest exploratory activities. These technical adaptations allow the generative artificial intelligence model to produce reports that are not only aligned with the current snapshot of characteristic information but also with long-term patterns.
The server thereby improves the internal operation of the computer system in several ways. First, the server reduces noise and redundancy in the input data by systematic preprocessing and feature extraction, which reduces the dimensionality of inputs to the machine learning model and leads to improved calculation efficiency and reduced computation time on the processor and any accelerator. Second, the server's use of structured data structures for behavior logs, feature data, characteristic information, and activity information allows efficient indexing and retrieval, decreasing storage access latency and improving throughput for concurrent requests. Third, the integration of analysis and prompt generation creates a controlled interface to the generative artificial intelligence model that avoids arbitrary or inconsistent prompts, improving the determinism and stability of the generated output. Fourth, the feedback-based updating of models and the use of time-series analysis produce a closed-loop adaptation mechanism that reduces error rates in recommendations and improves prediction quality, which is not achievable by manual rule updates or static systems.
The system does not merely automate human judgment. Instead, the server executes non-conventional, model-driven transformations that utilize high-dimensional feature spaces, gradient-based learning, and temporal statistical analysis, which are infeasible to reproduce manually with comparable precision or speed. The use of specific network architectures, loss functions, and optimization steps to derive characteristic information and activity selections constitutes an improvement to the technical field of computer-implemented analysis and recommendation systems. The structured prompt generation procedure and integration with the generative artificial intelligence model further optimize the computational pipeline by transforming intermediate analysis outputs into inputs that maximize the utility of generative capabilities while maintaining control over content and resource usage.
In alternative embodiments, the server may adopt different machine learning architectures. For example, the feature extraction model may be a recurrent neural network or a convolutional network configured for text, and the characteristic estimation model may be a multi-task learning model sharing lower layers across multiple prediction tasks. The recommendation model may be replaced by a graph-based model that encodes relations among activities and interest domains. The generative artificial intelligence model may be an encoder-decoder architecture instead of an autoregressive decoder-only architecture. In each case, the server maintains the core data flow: descriptive information to feature data, feature data to characteristic information, characteristic information to activity information, analysis result data to prompt sentence, and prompt sentence to analysis report.
The terminal may be implemented as various devices such as a smartphone, a tablet, a notebook computer, or a smart home device with a display. The user interface on the terminal may provide different layouts or interactive elements, but the fundamental operations of sending descriptive information, receiving notification data, and displaying analysis reports remain the same. The server may be hosted in a cloud computing environment, implemented as one or more virtual machines or containers, and may scale horizontally to handle multiple users simultaneously. The technical features described above, including structured preprocessing, integrated model-based analysis, adaptive feedback learning, and temporally conditioned prompt generation, are preserved across such deployment variations.
The following describes the processing flow using FIG. 11.

### Step 1:

User operates the terminal to launch an application or web client and opens an input screen for child information.
Input: No prior system data; the user's intention to input information.
Output: A visible user interface with fields for child identifier, age, and free-text descriptive information.
User types descriptive information about the child's behavior, interests, and activities into a text field, and optionally selects structured attributes such as age range or preferred activity types. The terminal captures the keystrokes and selections through its input interface and buffers the entered values in memory.

### Step 2:

Terminal structures the user input into a request payload.
Input: Raw text and selected attributes entered by the user in Step 1.
Output: A structured data object, for example a record containing child identifier, user identifier, timestamp, and descriptive text.
Terminal generates a timestamp using its system clock, associates the child identifier and user identifier (from local storage or session data), and creates a structured record. Terminal converts the record into a serialized format such as JSON, and stores it temporarily in memory in preparation for transmission.

### Step 3:

Terminal transmits the structured data to the server via a communication network.
Input: The serialized request payload from Step 2.
Output: An encrypted network request sent to the server's network interface.
Terminal establishes a secure connection using a protocol such as HTTPS over TLS, encapsulates the serialized payload in an HTTP request, and sends the request to the server's address. The terminal uses its network stack to fragment the data into packets and transmit them through a wired or wireless interface.

### Step 4:

Server receives and parses the transmitted data.
Input: Encrypted HTTP request packets containing the structured payload from Step 3.
Output: A parsed data structure in server memory representing the child's descriptive information.
Server's network interface reassembles the packets, the communication stack terminates the TLS session to decrypt the data, and the application server reads the HTTP body. Server deserializes the payload (for example, from JSON into an internal object or record) and performs format checks to ensure that required fields such as descriptive text, child identifier, and timestamp are present and valid.

### Step 5:

Server stores the descriptive information as a behavior log.
   Input: The parsed record containing child identifier, user identifier, timestamp, and descriptive text from Step 4.
   Output: A persistent behavior log entry stored in a behavior log data structure in the storage device.
   Server assigns a unique log identifier, constructs a database insert command, and writes the record into a behavior log table. The server commits the transaction to ensure durability. The server may create indexes on child identifier and timestamp fields to support efficient retrieval in later processing.

### Step 6:

Server retrieves descriptive information for preprocessing.
Input: The log identifier or child identifier from the new behavior log entry stored in Step 5.
Output: A set of one or more descriptive text records loaded into memory for preprocessing.
Server executes a database query to fetch the recently stored descriptive text, and optionally retrieves a selected number of recent logs for the same child to provide a broader context.
The server aggregates the retrieved text fields into a list or concatenated text sequence for subsequent natural language processing.

### Step 7:

Server performs text normalization and segmentation.
Input: Raw descriptive text strings obtained in Step 6.
Output: A cleaned token sequence (or multiple sequences) representing normalized and segmented text.
Server executes a character string processing program that converts all alphabetic characters to a uniform case, normalizes numerals and punctuation, and resolves variant characters into canonical forms. Server then applies a tokenizer to split the normalized text into tokens (words or subwords) according to a predefined vocabulary and language rules. The server may also segment the text into sentence units. These operations transform unstructured text into a consistent sequence of tokens, which reduces ambiguity and prepares the data for numerical encoding.

### Step 8:

Server removes unnecessary terms and performs lexical simplification.
Input: The token sequence from Step 7.
Output: A reduced token sequence with stop words removed and tokens optionally lemmatized or stemmed.
Server compares each token against a stop word list stored in the storage device, discards tokens that match entries in the list, and retains tokens likely to carry semantic content.
Server may apply a lemmatizer or stemmer to map inflected forms to base forms (for example, mapping “playing” and “played” to “play”). This data processing reduces dimensionality and noise, improving the efficiency and effectiveness of subsequent feature extraction.

### Step 9:

Server generates feature data using a natural language processing model.
Input: The reduced token sequence from Step 8.
Output: A fixed-dimensional vector or a set of vectors representing the semantic content of the descriptive information.
Server maps each token to an embedding vector using a learned embedding matrix stored in memory, then feeds the sequence of embeddings into a neural network architecture such as a transformer encoder. The server computes self-attention weights, applies linear transformations and non-linear activation functions, and produces hidden state vectors. The server then aggregates the hidden states (for example, by taking the vector corresponding to a special classification token or by averaging token vectors) to obtain a single feature vector.
The server writes this feature vector into a feature data structure indexed by the behavior log identifier.

### Step 10:

Server computes characteristic information using a machine learning model.
Input: The feature vector generated in Step 9.
Output: A characteristic vector comprising scores for multiple interest domains and learning tendencies.
Server forwards the feature vector to a trained machine learning model, such as a multi-layer perceptron. The model calculates activations layer by layer, using weight matrices and bias terms stored in memory. The final layer applies an activation function such as sigmoid or softmax to produce normalized scores. These scores represent probabilities or intensity levels for categories like specific topics of interest and learning styles. The server stores the resulting characteristic vector in the characteristic data structure associated with the child and timestamp.

### Step 11:

Server selects candidate activities using rule-based logic.
Input: The characteristic vector from Step 10.
Output: A preliminary set of candidate activities satisfying rule-based criteria. Server evaluates each component of the characteristic vector against thresholds defined in a rule set. For each interest domain whose score exceeds a specified threshold, the server selects corresponding activity templates from an activity catalog. For example, when a score for a category related to prehistoric animals exceeds a threshold, the server selects activities such as visiting a relevant exhibition, reading themed books, or engaging in themed crafts.
The server compiles a list of candidate activities tagged with their associated domains.

### Step 12:

Server refines activity selection using a recommendation model.
Input: The characteristic vector from Step 10 and the candidate activity list from Step 11, optionally combined with historical feedback data.
Output: A ranked list of activities and a selected subset of recommended activities.
Server encodes each candidate activity into a feature representation, for example by using activity attributes (type, difficulty, duration) and domain tags. Server inputs the concatenated child characteristic vector and activity features into a recommendation model such as a ranking neural network or a factorization model. The model calculates a relevance score for each candidate activity. Server sorts the candidate activities according to these scores and selects a subset that meets ranking and diversity criteria. The server stores the final activity information in the activity data structure.

### Step 13:

Server composes analysis result data.
Input: The characteristic vector from Step 10 and the selected activity information from Step 12.
Output: An analysis result record that combines characteristic information and activity information for a specific child.
Server creates a record containing identifiers for the child and session, the characteristic scores, and detailed attributes of each selected activity. The server stores this record in an analysis result data structure, which is used as an intermediate representation for prompt generation. By consolidating relevant data into one structure, the server reduces the need for repeated database lookups and streamlines subsequent operations.

### Step 14:

Server constructs a prompt sentence for a generative AI model.
Input: The analysis result record from Step 13, including characteristic scores and selected activities.
Output: A prompt sentence expressed in natural language that encodes instructions and context for the generative AI model.
Server loads a prompt template from storage that contains placeholders for interest domain names, scores, and activity descriptions. Server fills in these placeholders with concrete values from the analysis result record, generating a coherent instruction text. For example, the server may generate a prompt sentence such as:
“You are an educational advisor. A child shows strong interest in dinosaurs (score 0.93) and high interest in science (score 0.81). Using this information, write a concise, parent-friendly report that (1) summarizes the child's interests and strengths in one paragraph, and (2) recommends three concrete activities, such as museum visits, books, or home projects, related to dinosaurs and basic science. Output in English.”
This data processing maps structured characteristic and activity data into a natural-language instruction that conditions the behavior of the generative AI model in a precise and reproducible way.

### Step 15:

Server generates an analysis report using a generative AI model.
Input: The prompt sentence produced in Step 14.
Output: A natural-language analysis report describing the child's characteristics and recommended activities.
Server sends the prompt sentence as text input to a generative AI model, either via an external service interface or an internal model execution module. The generative model processes the prompt token by token, computing probability distributions over the next token based on internal weights and the prompt context. The server samples or selects tokens according to configured decoding parameters until an end condition is met. The resulting sequence of tokens is converted back to text as a response sentence. The server treats this response sentence as the analysis report and stores it in the report data structure alongside metadata such as model version and generation parameters.

### Step 16:

Server formats the analysis report as notification data.
Input: The analysis report from Step 15 and associated metadata.
Output: Notification data suitable for delivery to the terminal, including a summary and a reference to the full report.
Server constructs a notification object containing at least a short title, a brief summary of the report, and an identifier to retrieve the full report content. The server encodes the notification object in a format compatible with a notification service or application protocol. This transformation reduces payload size for initial delivery while preserving a link to richer content.

### Step 17:

Server sends the notification data to the terminal.
Input: The notification data created in Step 16 and the address or token associated with the user's terminal.
Output: A network message transmitted to the terminal, causing a user-visible notification. Server communicates with a push notification service or directly with the terminal over a network protocol, sends the notification data, and receives confirmation of delivery. This step uses the server's network interface to route the message through the communication network to the terminal's network interface.

### Step 18:

Terminal receives and presents the notification.
Input: The notification message sent in Step 17.
Output: A visible notification on the terminal's display, including text such as a title and summary.
Terminal's operating system delivers the notification payload to the application, which parses the payload and constructs a user interface element. Terminal displays the notification, including the report title and a short description, and may show an icon or alert sound to attract the user's attention. The terminal stores the notification state so the user can open it later.

### Step 19:

User opens the notification and requests the full report.
Input: The visible notification presented in Step 18.
Output: A user action triggering a request from the terminal to the server for the full report. User touches or clicks the notification. Terminal interprets this input event, launches or brings the application to the foreground, and generates a request including the report identifier obtained from the notification data. The terminal sends this request via the communication network to the server, typically using HTTPS.

### Step 20:

Server returns the full analysis report and related data.
Input: The report retrieval request from Step 19, including the report identifier.
Output: A response containing the full analysis report text, the list of recommended activities, and any additional analysis details.
Server validates the request, retrieves the report content from the report data structure, and looks up the related activity and characteristic information if needed. Server consolidates this information into a response payload and transmits it back to the terminal over the network.
This processing step converts internal structured representations and stored text into a formatted response suitable for rendering on the terminal.

### Step 21:

Terminal renders the report for the user.
Input: The response payload from Step 20 containing the analysis report and activity data.
Output: A graphical display presenting the report text and recommended activities to the user.
Terminal parses the response, separates elements such as summary, detailed explanation, and activity list, and constructs a screen layout. Terminal displays the analysis report text in readable paragraphs and arranges recommended activities in a list or grid showing titles, descriptions, and any relevant tags. This display enables the user to understand the inferred characteristics and to select concrete activities.

### Step 22:

User provides feedback on the recommended activities.
Input: The displayed report and activity list from Step 21.
Output: User-entered feedback data indicating evaluation or execution results.
User interacts with the interface to indicate which activities were tried, how successful they were, and how the child responded. User may select options such as ratings or categorical responses and may enter free-text comments. Terminal captures this feedback and organizes it into a feedback record including activity identifiers, evaluation scores, and optional comments.

### Step 23:

Terminal transmits feedback data to the server.
Input: The feedback record constructed in Step 22.
Output: A feedback request message delivered to the server through the communication network.
Terminal serializes the feedback record, attaches relevant identifiers (child, report, user), and sends the data via a secure protocol such as HTTPS. The terminal may batch multiple feedback records to reduce communication overhead.

### Step 24:

Server stores feedback as history data.
Input: The feedback message received in Step 23.
Output: One or more history records saved in a history data structure associated with children and activities.
Server deserializes the feedback payload and writes each feedback item to a history table, logging the time, identifiers, and feedback content. Server may index the history records by child identifier and activity identifier to support efficient querying during model updates.

### Step 25:

Server updates training data and model parameters based on history data.
Input: Accumulated history records from Step 24 and existing training data for the machine learning and recommendation models.
Output: Updated model parameters and, optionally, updated training datasets stored in the storage device.
Server periodically queries the history data to construct new training instances, where characteristic vectors and proposed activities form inputs, and feedback signals form targets.
The server computes a loss function, such as cross-entropy between predicted engagement probabilities and actual feedback labels, and performs gradient-based optimization to adjust model weights. The server writes updated parameters back to the storage device. This data processing closes the loop between user interaction and model behavior, enabling the system to refine prediction accuracy and recommendation quality over time.

### Step 26:

Server analyzes time-series patterns in child characteristics.
Input: Sequences of characteristic vectors and associated timestamps stored for a child over multiple sessions.
Output: Temporal analysis results indicating trends and change patterns in interest domains and learning tendencies.
Server retrieves characteristic vectors for a given child across time and feeds them into a time-series analysis algorithm such as a recurrent neural network, a temporal convolution model, or a statistical time-series model. The algorithm computes temporal features like trend slopes, volatility measures, and transition probabilities between interest domains. Server summarizes these metrics as change patterns and stores them in a temporal analysis data structure. These results quantify how the child's interests and learning tendencies evolve.

### Step 27:

Server adjusts future prompt sentences and reports based on temporal analysis.
Input: The current analysis result data from a new session and the temporal analysis results from Step 26.
Output: Modified prompt sentences and analysis reports that reflect both current and longitudinal characteristics.
Server reads trend and change pattern information, and modifies the prompt template selection or the content of specific placeholders. For example, when a stable long-term interest is detected, the server instructs the generative AI model via the prompt sentence to provide more advanced or long-term activity plans. When a recent change is detected, the server instructs the model to emphasize exploration and variety. These adjustments are encoded in the natural-language instructions included in the prompt sentences. As a result, the generative AI model produces reports that better match the child's developmental trajectory, improving the technical effectiveness of the overall system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems for children's play, educational activities, and consumer goods generally rely on static rule sets, manually designed questionnaires, or simple filtering based on age and broad interest categories. Such systems suffer from several technical limitations when deployed on modern networked computing infrastructures. First, conventional systems typically treat user input as coarse, unstructured text or numeric fields and do not systematically transform this input into machine-interpretable feature vectors suitable for advanced machine learning. As a result, server-side computation cannot fully exploit correlations between different types of child-related information, such as behavior, detailed interest expressions, and activity history, and thus generates low-resolution recommendations.

Second, in many existing architectures, any use of generative artificial intelligence models is performed in an ad hoc manner. For example, free-form prompts are manually crafted or loosely constructed without being grounded in a formal analytical representation of the child's characteristics. This leads to non-deterministic or noisy outputs, weak alignment with underlying data, and increased computational waste, because the generative models are not systematically steered by structured analysis results computed on the server.
Third, typical systems do not close the loop between user interactions and the underlying computational models. Feedback such as which recommendations are viewed, selected, or acted upon is often either ignored or used only for simple statistics. The server therefore operates with static models that do not improve their internal representations and prompt construction logic over time. This prevents the system from adapting to evolving child characteristics and from improving personalization performance at the level of model parameters and feature pipelines.
Fourth, while some systems attempt to adjust recommendations based on user satisfaction, they frequently rely on coarse measures such as click-through rates or explicit ratings. These systems do not integrate low-latency analysis of voice signals to infer a user's emotional state and do not technically couple such emotional context with the construction of prompts or recommendation texts. The server thus misses an opportunity to dynamically shape the length, tone, and ordering of recommendation content based on real-time emotional parameters, resulting in suboptimal human-computer interaction and increased cognitive load for the user.
Fifth, many existing solutions treat historical child data in a purely static fashion, for example by storing previous responses and reusing them as-is. They do not apply time series analysis at the feature level to detect longitudinal changes in a child's characteristics. Consequently, the server cannot compute a characteristic change index or systematically inject such temporal insight into the generative process. This leads to recommendations that may ignore developmental progress, regressions, or shifting interests over time, thereby degrading the technical effectiveness of the recommendation pipeline.
Accordingly, there is a need for a technical architecture that improves the way a server receives and encodes heterogeneous child-related input, computes and maintains feature-level models of child characteristics, systematically constructs prompt sentences for a generative AI model from those models, integrates real-time emotional parameters, and exploits time series analysis over historical feature data. Such an architecture should allow the server to update learning models based on feedback signals from a terminal device and to generate, in a computationally efficient and data-consistent manner, natural language recommendation data that is more accurately personalized for each child. The present invention is directed to solving these computer-technical problems by providing a concrete server-side processing pipeline and data structures that operationally bind feature extraction, model inference, prompt generation, generative AI invocation, and feedback-based model updating into a unified system.

The specific processing by the specific processing unit 290 of the data processing device 12 in Application Example 1 is realized by the following means.

The present invention provides a server comprising a processor and a communication interface, the processor being configured to receive, via the communication interface, structured data including information on behavior, interest, and activity of a child that is input by a user through a terminal device; preprocess the structured data using a natural language processing algorithm and a statistical learning algorithm to convert text information and attribute information into feature data represented as numerical vectors and to calculate analysis result data indicating characteristics and interest tendencies of the child; generate, based on the analysis result data, prompt generation data by summarizing age, target of interest, behavior history, and activity history of the child according to a template generation algorithm and constructing a prompt sentence including the summarized contents; transmit generation request data including the prompt generation data to a generative artificial intelligence model so as to cause the generative artificial intelligence model to generate natural language recommendation data relating to at least one of a play, an educational activity, and an article suitable for the child, and acquire the natural language recommendation data from the generative artificial intelligence model; associate the natural language recommendation data with candidate content information stored in a storage device to generate report data indicating at least one of a play, an educational activity, and an article suitable for the child, and output the report data to the terminal device; receive, from the terminal device, operation history data indicating at least one of viewing, selecting, purchasing, and participating operations performed by the user with respect to the report data; and update, using the operation history data, a learning model used for the generation of the feature data and the calculation of the analysis result data so as to generate learning update data configured to personalize, for each child, the prompt sentence and the natural language recommendation data to be generated in subsequent processing. This enables the server to implement an improved end-to-end computational pipeline in which child-related input is transformed into structured features, analyzed to derive characteristic models, encoded into systematically constructed prompt sentences for a generative AI model, and refined over time through feedback-driven model updates, thereby improving the accuracy, stability, and personalization quality of machine-generated recommendations in a technically efficient manner.

The term “processor” refers to one or more hardware computation units, such as central processing units or specialized processing circuits, that execute instructions of a program to perform data processing operations described in the present specification.

The term “communication interface” refers to a hardware and software interface configured to send and receive data between the server and external devices, including but not limited to network interfaces for wired or wireless communication.
The term “terminal device” refers to an end-user computing apparatus operated by a user, such as a mobile device, a tablet device, a portable information processing device, or a general-purpose computer, that is configured to present user interfaces and to transmit user input to the server.
The term “user” refers to a human operator who interacts with the terminal device to input information, review recommendations, and perform operations such as viewing, selecting, purchasing, or participating in activities.
The term “child” refers to a human individual for whom behavior, interest, and activity information is collected and analyzed by the system for the purpose of generating recommendations.
The term “structured data” refers to data organized according to a predefined format, such as key-value pairs, records, or objects, which may be represented, for example, in a markup or notation format and which includes identifiable fields corresponding to behavior, interest, and activity of a child.
The term “behavior” refers to observable actions or conduct of a child in daily life or specific contexts, such as visiting certain places, engaging in particular types of play, or exhibiting repeated patterns of interaction.
The term “interest” refers to a preference, curiosity, or attraction of a child toward particular topics, themes, genres, or domains, such as scientific subjects, artistic themes, or specific characters.
The term “activity” refers to an identifiable task, play, learning exercise, or participation in an event in which a child engages, including both physical activities and digital or cognitive activities.
The term “natural language processing algorithm” refers to a computational method or set of methods that process and analyze text data expressed in a human language, including but not limited to tokenization, normalization, feature extraction, or embedding generation.
The term “statistical learning algorithm” refers to a computational method that uses statistical techniques to derive a model from data, including but not limited to classification models, regression models, clustering models, or dimensionality reduction models.
The term “feature data” refers to numerical representations of input data, including text information and attribute information, that are generated through preprocessing and suitable for use by a learning model.
The term “numerical vector” refers to an ordered collection of numerical values that encodes properties of input data, such as term frequencies, embedding coordinates, or normalized attributes.
The term “analysis result data” refers to structured information computed from feature data by one or more learning models, indicating inferred characteristics, tendencies, or categories associated with a child.
The term “characteristics” refers to inferred properties of a child, including but not limited to preferences, learning styles, strengths, weaknesses, and behavioral tendencies as estimated by a computational model.
The term “interest tendencies” refers to patterns or directions of a child's preferences among different topics or activity types, as determined by analyzing feature data.
The term “template generation algorithm” refers to a computational procedure that constructs natural language or structured expressions by filling predefined templates or patterns with variable content obtained from analysis result data.
The term “prompt generation data” refers to structured data representing a prompt sentence or a set of prompt components that are intended to be provided as input to a generative artificial intelligence model.
The term “prompt sentence” refers to a text string constructed in a natural language that describes context, constraints, and instructions, and that is supplied as an input to a generative artificial intelligence model to guide content generation.
The term “behavior history” refers to a record of past behavior-related data of a child accumulated over time and associated with time points or intervals.
The term “activity history” refers to a record of past activities of a child, including participation in events, exercises, or tasks, associated with corresponding time information.
The term “generative artificial intelligence model” refers to a machine learning model configured to generate new content, such as natural language text, conditioned on input data including prompt sentences and other contextual information.
The term “generation request data” refers to a data structure or message that includes at least the prompt generation data and that is transmitted from the server to the generative artificial intelligence model to request generation of output content.
The term “natural language recommendation data” refers to text output produced by the generative artificial intelligence model in a human language, describing recommended plays, educational activities, or articles suitable for a child.
The term “candidate content information” refers to data describing possible items to be recommended, such as plays, educational activities, or articles, including at least identifiers, descriptive text, and one or more attributes such as age range or category.
The term “information storage device” refers to a storage component, such as a non-volatile memory or a database system, that stores candidate content information, historical data, or model-related data.
The term “report data” refers to structured data that combines natural language recommendation data with candidate content information to indicate specific plays, educational activities, or articles suitable for a child for presentation to a user.
The term “output data” refers to data transmitted from the server to the terminal device that encapsulates at least the report data for display or further interaction.
The term “operation history data” refers to data indicating operations performed by a user on the terminal device with respect to displayed report data, including at least one of viewing events, selection events, purchasing events, and participation registrations.
The term “learning model” refers to a computational model obtained through a learning process using training data, which maps input feature data to output values such as analysis result data.
The term “learning update data” refers to data generated as a result of updating parameters or structures of a learning model based on operation history data, to improve subsequent inference or recommendation behavior.
The term “personalize” refers to adjusting at least one of feature generation, analysis result calculation, prompt construction, or recommendation content so that the outputs are tailored to individual characteristics of a specific child.
The term “voice data” refers to audio data representing spoken utterances of a user, acquired through a microphone or other acoustic sensor associated with the terminal device.
The term “voice analysis algorithm” refers to a computational method that processes voice data to extract features related to prosody, pitch, intensity, or other acoustic characteristics for subsequent estimation of an emotional state.
The term “emotion parameter” refers to one or more values calculated from voice data or other signals that represent an estimated emotional state of a user, such as calmness, excitement, satisfaction, or frustration.
The term “control data” refers to data used to modify or adjust the generation, formatting, or presentation of natural language recommendation data, including modification of writing style, level of detail, and presentation order based on an emotion parameter.
The term “writing style” refers to linguistic aspects of natural language text, such as formality, tone, sentence length, or use of explanatory phrases.
The term “level of detail” refers to the degree of specificity or elaboration included in recommendation text, such as the number of examples, the length of explanations, or the amount of contextual information.
The term “presentation order” refers to the sequence or ranking in which recommended items or textual segments are presented to a user in a user interface.
The term “history information storage device” refers to a storage component that retains historical structured data and historical analysis result data for a plurality of children over time.
The term “historical structured data” refers to structured data collected at previous time points, including past behavior, interest, and activity information of a child.
The term “historical analysis result data” refers to past instances of analysis result data that were previously computed from historical feature data of a child.
The term “time series analysis algorithm” refers to a computational method for analyzing temporal sequences of data to detect trends, periodicities, or changes over time, such as methods for comparing feature vectors across different time points.
The term “feature data” in a time series context refers to feature vectors computed at different time points from child-related input, forming a temporal sequence for analysis.
The term “characteristic change index” refers to a numerical or categorical indicator representing a magnitude or direction of change in one or more characteristics of a child across time, as derived from time series analysis of feature data.
The term “time series evaluation data” refers to data that encodes results of time series analysis, including at least a characteristic change index, for use in modifying prompt sentences or natural language recommendation data.
The term “play” refers to an activity mainly intended for entertainment or creative engagement of a child, which may also carry educational aspects.
The term “educational activity” refers to an activity designed primarily to support learning or skill development of a child in a structured or semi-structured manner.
The term “article” refers to a tangible or digital item, such as a toy, a book, or an electronic content item, that may be recommended for use by a child.

In the following embodiments, a server, a terminal, and a user cooperate to implement a system for generating personalized recommendations for children's play, educational activities, and articles. The embodiments are provided by way of example and are not limiting. The same reference architecture can be applied with various hardware and software stacks.

### 1. Overall Hardware and Software Configuration

The server executes one or more programs on a processor. The server includes at least: a central processing unit (CPU), a main memory (RAM), a non-volatile storage device such as a solid-state drive (SSD), a network interface controller, and optionally one or more graphics processing units (GPUs) for accelerating machine learning operations. The server runs an operating system such as a general-purpose server operating system, and executes an application framework such as a web application framework implemented in Python (for example, a framework of the Flask, Django, or FastAPI type), together with a front-end HTTP server of the reverse-proxy type.
The terminal includes a mobile device, tablet, or similar computing device equipped with a processor, memory, touch screen, microphone, speaker, network transceiver, and an operating system such as a mobile operating system. The terminal executes a native or hybrid application that implements the user interface and communication with the server.
The server stores program modules and data in a storage device. Example modules include: a communication module, a parsing and validation module, a natural language processing (NLP) module, a feature generation module, one or more learning models implemented in libraries of the scikit-learn or TensorFlow type, a prompt construction module, a generative AI interface module, a recommendation assembly module, a feedback logging module, a model updating module, and a time series analysis module. The modules communicate through defined data structures in memory.

### 2. Data Representation and Structures

The server uses structured data representations that improve computational efficiency and reliability. The server represents user-submitted child information as records with fixed fields (e.g., child identifier, age, behavior text, interest text, activity text, timestamps, and optional categorical attributes). The server materializes these records as objects or rows in a database, and as in-memory data structures, such as dictionaries or arrays, usable by Python-based processing pipelines.
The server represents feature data as numerical vectors of fixed dimension. For example, the server uses a text vectorization scheme such as TF-IDF (term frequency-inverse document frequency) implemented by a scikit-learn type vectorizer, or dense vector embeddings generated by a neural network model implemented in TensorFlow. The server concatenates text-derived vectors with normalized numeric attributes (e.g., age, activity counts) into a single feature vector. The server stores these feature vectors as dense arrays in memory and may optionally persist them in a feature store or database table.
The server stores candidate content information (for plays, educational activities, and articles) in a relational database (for example, of the PostgreSQL or MySQL type), with fields including item identifier, title, description text, target age range, category labels, and metadata such as difficulty level or required time. The server may precompute and store embedding vectors for these items to enable fast similarity computations.

### 3. Learning Model Configuration and Internal Algorithms

The server uses multiple learning models to compute analysis result data. In one embodiment, the server loads a first model implemented in a library of the scikit-learn type, such as a Random Forest classifier. The server trains the model using historical feature data as inputs and category labels (e.g., interest categories like science, art, or sports) as outputs. The server stores the learned decision trees as structured data in a file, including thresholds, feature indices, and split criteria. This configuration enables fast inference at runtime, because the server evaluates only a subset of features per decision node.
The server further uses a neural network model implemented in a framework of the TensorFlow/Keras type. In one example, the server uses a feed-forward neural network with an input layer dimension equal to the feature vector dimension, one or more hidden layers with nonlinear activation functions such as rectified linear units (ReLU), and an output layer that produces continuous scores representing estimated strengths (e.g., reading preference, puzzle preference, social activity preference). The server trains this model using supervised learning: the server defines a loss function such as mean squared error (MSE) between predicted scores and ground-truth labels, and uses backpropagation and a gradient-based optimizer (for example, an Adam-type optimizer) to update the weights. The server may augment training data via data augmentation (e.g., synonym replacement in texts, slight perturbation of numeric features) to improve robustness.
By structuring the models in this way, the server improves computational efficiency: the Random Forest classifier yields discrete category predictions suitable for indexing and filtering candidate items, while the neural network outputs continuous preference scores suitable for fine-grained ranking.
The server may also maintain an embedding generator model for text, implemented for example as a neural network with an embedding layer and a pooling layer. Such a model can be a transformer-based encoder or a simpler recurrent or convolutional architecture. The server uses these embeddings to compute cosine similarities between child feature vectors and item vectors, which improves matching accuracy over simple keyword-based approaches.

### 4. Prompt Construction and Generative AI Model Interface

The server configures a prompt construction module that converts analysis result data into prompt sentences. The server uses a deterministic template generation process implemented as a rule-based algorithm. The server, for instance, defines templates with placeholders for age, interest topics, recent behaviors, and activities. The server fills the placeholders with values from analysis result data and cleans and normalizes phrases to maintain grammatical and semantic consistency.
In one typical embodiment, the server generates a prompt sentence such as:
“Child's age: 7. Child's interests: dinosaurs, science. Recent behavior: visited a dinosaur museum and spent a long time at the dinosaur exhibits. Recent activities: enjoys assembling jigsaw puzzles and reading illustrated books. Based on these characteristics, please propose 5-7 concrete products and activities (such as books, puzzles, and outings) that are appropriate for this child's developmental stage. For each suggestion, briefly explain in friendly language why it is suitable. Use concise bullet points.”
The server thereby converts internal numerical features and categorical labels into human-readable but strongly structured input for a generative AI model, reducing ambiguity and guiding model behavior.
The server interfaces with a generative AI model over a network. The generative AI model itself may be hosted externally as an API service or internally on specialized hardware. In an internal configuration, the generative AI model may be a transformer-based language model with multiple attention layers, trained on large corpora of text. The server passes prompt sentences and meta-parameters such as maximum output length, temperature, and top-k or top-p sampling parameters, to control the stochastic behavior of the model. The server receives natural language recommendation data as generated text.
The server improves computer technology by imposing a structure on prompts and by coupling them with feature-level analytical context. This approach reduces the number of iterations required to obtain relevant outputs, thereby reducing network traffic and CPU/GPU usage associated with repeated generative calls. The deterministic prompt construction also enables caching strategies: when similar analysis results occur, the server can reuse or partially reuse prompts or past outputs, thereby reducing processing time and communication load.

### 5. Recommendation Assembly and Presentation

The server associates the natural language recommendation data with candidate content information. The server parses the generated text using lightweight NLP routines (e.g., keyword detection, item name recognition) to link segments of text to specific items in the database. Alternatively, the server uses the previously computed item ranking to select the top items and null out any generated text that refers to items outside the curated set. The server then constructs report data that includes: the recommendation text, a list of selected items with identifiers, titles, summaries, and links, and any metadata such as age suitability or difficulty level.
The terminal receives this report data through the communication interface. The terminal displays the natural language recommendation text in a scrollable area and presents each recommended item with an image, a descriptive text, and interactive controls such as “details,” “add to cart,” or “register.” The user reads the recommendations and selects actions. Because the server integrates structured analysis with generative phrasing, the displayed information is both technically precise and human-comprehensible.

### 6. Emotional Context Handling

The server can optionally consider emotional context. The terminal acquires voice data from the user via the microphone, for example when the user asks questions or expresses reactions.
The terminal sends audio signals to the server. The server processes the audio using a voice analysis algorithm, such as a pipeline that includes: pre-emphasis filtering, framing, windowing, extraction of acoustic features such as Mel-frequency cepstral coefficients (MFCCs), pitch, energy, and spectral characteristics. The server then feeds these features into a classifier model (e.g., a neural network or support vector machine) trained to output an emotion parameter indicating categories such as “relaxed,” “confused,” or “excited.”
The server uses the emotion parameter to adjust both the prompt sentence and the report data. For example, when the emotion parameter indicates confusion or frustration, the server modifies the prompt sentence to request more detailed, step-by-step explanations, or to broaden the diversity of recommendations. The server can generate a modified prompt sentence such as:
“Please explain the recommended products and activities more slowly and clearly, using simple language suitable for a non-expert parent, and provide additional justification for each choice.”
The server thereby controls the generative AI model with explicit technical parameters, resulting in outputs tailored to the real-time emotional state. This dynamic adjustment improves user comprehension and reduces the number of follow-up requests, which directly improves computational efficiency by reducing redundant server-client communications and repeated generative calls.

### 7. Time Series Analysis and Longitudinal Modeling

The server maintains a history information storage device to store historical structured data and historical analysis result data for each child. For each new session, the server retrieves past feature vectors and corresponding timestamps. The server applies a time series analysis algorithm, such as computing differences between feature vectors, applying exponentially weighted moving averages, or modeling sequences with recurrent neural networks or temporal convolutional networks.
The server calculates a characteristic change index, for example by computing the Euclidean distance or cosine distance between current and past feature vectors, possibly aggregated over categories (e.g., change in science interest vs. change in art interest). When the change index passes a threshold, the server recognizes significant transitions in the child's preferences or capabilities.
The server reflects this temporal insight in the prompt sentence and natural language recommendation data. For example, the server can construct a prompt sentence such as: “Over the past 6 months, the child's interest in independent reading has increased, while interest in simple puzzles has decreased. Please recommend activities and products that gently increase difficulty in reading and reasoning, and reduce emphasis on very simple puzzles.”
By explicitly encoding longitudinal changes in this way, the server ensures that the recommendation pipeline is sensitive to developmental evolution, rather than static snapshots. This improves accuracy and reduces the likelihood of stale or inappropriate recommendations.

### 8. Feedback-Driven Model Updating

The terminal records operation history data such as which items were viewed, which ones were selected for more details, which were purchased, and which activities were registered.
The terminal sends this data to the server. The server logs it into a feedback store with timestamps and child identifiers.
The server uses this feedback to update its learning models. For instance, the server can define a loss function for the ranking model that penalizes high scores assigned to items that were ignored and rewards high scores for items that led to purchases or registrations. The server then performs batch or incremental learning: the server periodically retrieves new feedback data, recomputes gradients with respect to model parameters, and performs weight updates. For the neural network, the server applies gradient descent steps with regularization to avoid overfitting. For the Random Forest or similar models, the server may rebuild trees with updated training sets at scheduled intervals.
This feedback-driven approach is not equivalent to manual human tuning. The server exploits high-dimensional feature representations and large volumes of interaction data, and optimizes its model parameters in a way that would be infeasible for a human operator. The system thus improves recommendation precision (fewer irrelevant suggestions) and reduces user interaction latency (fewer screens and steps to find suitable items), which are concrete technical improvements.

### 9. Technical Effects and Non-Abstract Character

The server improves computer technology along multiple axes:
The server reduces communication overhead by constructing precise prompt sentences that reduce back-and-forth between server and generative AI model. Shorter and more targeted prompts yield more relevant outputs in fewer calls, which reduces network bandwidth consumption and processing time on both the server and the generative AI host.
The server improves computation efficiency by using structured feature vectors and modular models (classification, preference scoring, time series analysis) to filter and rank items before invoking a generative AI model. This reduces the search space that must be verbally described and reduces the content that must be generated, thereby shortening inference time and minimizing unnecessary model computation.
The server improves data management by storing child-related data, feature vectors, analysis results, and operation histories in well-defined structures that enable time series analysis, longitudinal modeling, and reproducible prompt construction. This structured management permits efficient indexing, caching, and batched processing.
The server improves accuracy and reduces error by combining deterministic prompt construction with model-driven analysis. Unlike systems that rely on free-form or manually written prompts, the server systematically ties each element of the prompt sentence to model outputs derived from feature-level analysis. This reduces misalignment between input data and generated text, increasing the probability that recommendations match the child's needs.
The server implements rules and algorithms that are not conventional in manual human workflows. A human might read a child's profile and write a recommendation, but the server performs high-dimensional vector computations, gradient-based learning, and time series feature analysis, and uses these to control generative models through structured prompts. These operations are specifically designed for digital computation and are not a straightforward automation of human mental steps.

### 10. Variants and Alternative Embodiments

The server may implement alternative NLP pipelines. For example, instead of TF-IDF, the server can use subword tokenization and transformer-based sentence encoders to produce dense embeddings. The feature generation module may integrate multiple embedding types (e.g., behavioral context embeddings and interest-topic embeddings) and merge them by concatenation or weighted averaging.
The server may select different architectures for the generative AI model, such as encoder-decoder transformers, autoregressive language models, or mixture-of-experts models. The server may adjust sampling parameters (e.g., temperature, nucleus sampling threshold) dynamically based on the emotion parameter and historical engagement metrics.
The server may use alternative time series algorithms, such as Hidden Markov Models or sequence-to-sequence models with attention, to capture complex temporal dynamics in children's interests. The server may also incorporate seasonal or calendar effects (e.g., school terms, holidays) into its analysis.
The server may execute on a distributed cluster where feature generation, model inference, and generative AI interaction are separated into microservices. In this configuration, each microservice uses standardized APIs and shared storage to pass intermediate data. This modular structure allows scaling of specific subsystems, such as the generative AI interface or the feature store, according to computational load, thereby improving system-level performance and fault tolerance.
The terminal may be any device capable of running an application and communicating with the server. In some embodiments, a smart display or home assistant device with a screen and microphone functions as the terminal. The user may interact via voice-only commands, and the terminal may read out recommendations using text-to-speech synthesis, driven by the same report data.
Through these embodiments, the server, the terminal, and the user cooperate to implement a concrete, technically detailed system. The system integrates structured feature extraction, model-based analysis, prompt sentence generation, and generative AI controlled by explicit parameters, with feedback and time series analysis, to achieve technical improvements in processing speed, recommendation accuracy, and resource utilization beyond mere automation of human cognitive tasks.

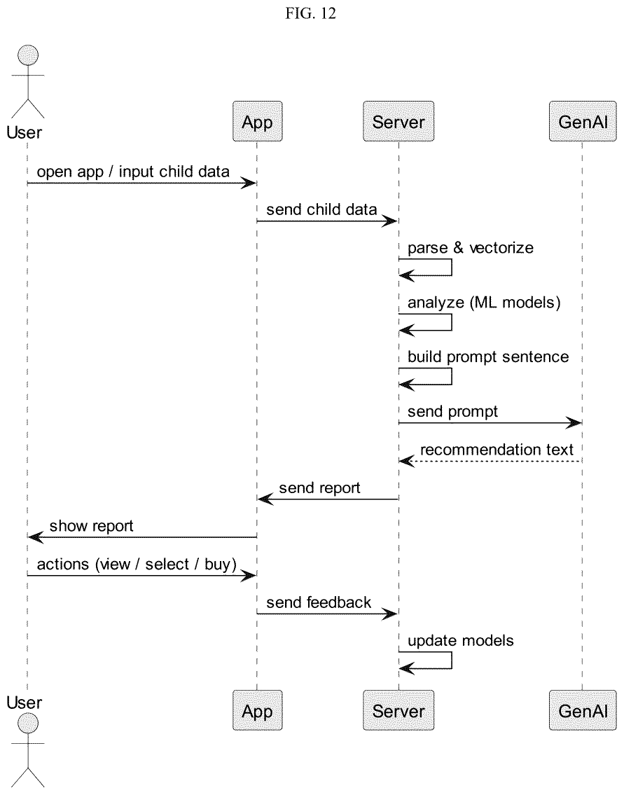

The following describes the processing flow using FIG. 12.

### Step 1:

The user operates the terminal to start an application and open an input screen for child information.
The terminal displays input fields for the child's age, behavior, interests, and activities.
Input: Touch operations and text spoken or typed by the user.
Processing: The terminal converts user interactions into internal UI events and populates in-memory variables with the entered texts and selected values.
Output: A structured representation of the user's input (e.g., in a key-value form held in the terminal's memory).

### Step 2:

The terminal validates the structured representation of the child information.
Input: The in-memory key-value representation (age, behavior text, interest text, activity text, and optional attributes).
Processing: The terminal checks data types and required fields (e.g., verifies that age is numeric and non-empty, that at least one interest or activity is specified, and that text length is within limits). If validation fails, the terminal generates error messages and prompts the user to correct inputs.
Output: Either (i) a validated structured dataset ready for transmission, or (ii) error indications shown to the user and a revised structured dataset after correction.

### Step 3:

The terminal packages the validated structured dataset into a transmission format and sends it to the server.
Input: Validated child information stored as key-value pairs.
Processing: The terminal serializes the dataset into a structured transmission format (such as JSON), adds metadata such as a session identifier and timestamp, and encapsulates the serialized data into an HTTP request over a secure protocol.
Output: A network request sent to the server that contains the child information as structured data.

### Step 4

The server receives the network request and parses the structured data.
Input: The HTTP request body containing serialized child information.
Processing: The server extracts the body, deserializes the content into server-side data structures, and verifies structural integrity (e.g., presence of expected keys, correct encoding).
The server logs reception metadata (IP address, request time, and request size) for monitoring.
Output: A normalized internal object containing age, behavior text, interest text, activity text, and optional attribute fields.

### Step 5:

The server preprocesses textual and non-textual fields and generates feature vectors.
Input: The normalized internal object with age, behavior, interest, activity, and attributes.
Processing: The server applies a natural language processing algorithm to behavior, interest, and activity texts (tokenization, lowercasing, stop-word removal, and optional lemmatization or morphological analysis). The server then uses a text vectorizer (e.g., TF-IDF or a neural embedding generator) to convert each text field into a numerical vector. The server encodes categorical attributes (e.g., grade, category tags) using encoders such as one-hot encoding and scales numeric values (e.g., age) with normalization functions. The server concatenates these vectors into a single fixed-dimensional feature vector representing the child's profile.
Output: A child feature vector and intermediate token/attribute structures stored in server memory.

### Step 6:

The server applies trained learning models to analyze the child's characteristics.
Input: The child feature vector from Step 5 and preloaded model parameters.
Processing: The server feeds the feature vector into a classification model (e.g., a Random Forest classifier) to infer discrete labels such as interest categories and learning styles, and into a neural network to compute continuous preference scores (e.g., for reading, puzzles, social activities). The server calculates output probabilities or scores, applies any decision thresholds, and aggregates these into analysis result data that includes predicted categories, strengths, weaknesses, and interest tendencies.
Output: Analysis result data representing the child's inferred characteristics and numerical preference scores.

### Step 7:

The server retrieves and filters candidate items from a content repository.
Input: Analysis result data (interest categories, age, difficulty level) and a database of items (plays, educational activities, and articles).
Processing: The server constructs and executes database queries using the inferred categories and age range to obtain a candidate set of items. The server optionally computes similarity scores between the child feature vector and pre-stored item feature vectors and ranks items by similarity and relevance.
Output: A ranked list of candidate items, each with identifiers, descriptions, and attributes, prepared for recommendation assembly.

### Step 8:

The server constructs a prompt sentence based on the analysis result data and candidate context.
Input: Analysis result data and, optionally, a subset of top-ranked candidate items.
Processing: The server uses a template-based algorithm to generate a structured description of the child (age, interests, recent behaviors, activities) and forms it into a natural-language prompt sentence for a generative AI model. The server inserts specific terms (e.g., “dinosaurs,” “puzzles,” or “reading”) and instructions on output format (e.g., number of suggestions, explanation style).
Output: A prompt sentence string ready to be provided as input to a generative AI model.

### Step 9:

The server sends the prompt sentence to a generative AI model and obtains recommendation text.
Input: The prompt sentence and model control parameters (e.g., maximum length, sampling temperature).
Processing: The server forms a generation request including the prompt sentence and parameters, transmits the request to a generative AI model (either hosted externally or internally), and waits for a response. The generative AI model processes the prompt and returns natural language recommendation data. The server then checks the returned text for format consistency and trims or sanitizes it if necessary.
Output: Natural language recommendation data describing suggested plays, educational activities, and articles suitable for the child.

### Step 10:

The server composes report data by merging recommendation text with concrete item information.
Input: Natural language recommendation data and the ranked candidate items from Step 7.
Processing: The server aligns portions of the recommendation text with specific items (e.g., by keyword matching or ranking-based mapping), selects a final subset of items, and builds report data that includes the generated explanation, item titles, descriptions, age ranges, and access links. The server encapsulates this information into a structured response object.
Output: Report data ready to be transmitted to the terminal, containing both descriptive text and structured item information.

### Step 11:

The server transmits the report data to the terminal.
Input: The structured response object containing report data.
Processing: The server serializes the report data into a transmission format, sets appropriate headers (e.g., content type and status code), and sends an HTTP response to the terminal. The server records information on the response (size, processing time) for system monitoring.
Output: A network response delivered to the terminal that includes the report data.

### Step 12:

The terminal receives and displays the report data to the user.
Input: The HTTP response containing serialized report data.
Processing: The terminal deserializes the response into a local data structure, extracts the recommendation text and the list of items, and renders them on the display. The terminal arranges text in paragraphs or bullet points and shows corresponding item components (images, titles, prices, buttons) in a scrollable view.
Output: A graphical user interface presenting the personalized recommendations for inspection by the user.

### Step 13:

The user reviews the displayed recommendations and selects actions.
Input: The visual presentation of report data on the terminal screen.
Processing: The user scrolls, taps items for details, or activates controls such as “purchase” or “register for activity.” These interactions generate UI events that the terminal captures and translates into interaction records.
Output: Interaction records indicating viewing, selection, and any purchasing or registration decisions made by the user.

### Step 14:

The terminal generates operation history data and sends it to the server.
Input: Interaction records derived from the user's actions in Step 13.
Processing: The terminal aggregates events (e.g., items clicked, items purchased, time spent on recommendation screens) into operation history data with timestamps and identifiers. The terminal serializes this data and sends it as a feedback request to a dedicated feedback endpoint on the server.
Output: Operation history data transmitted to the server for learning and analytics.

### Step 15:

The server updates learning models and personalization parameters using the operation history data.
Input: Operation history data and existing model parameters for feature generation, classification, ranking, and time series analysis.
Processing: The server interprets positive outcomes (e.g., purchases or registrations) and negative outcomes (e.g., ignored items) and assigns implicit labels or rewards to item-child pairs. The server recalculates gradients and updates neural network weights via optimization algorithms, or refits other models with extended training sets. The server may update thresholds, weights in scoring functions, and prompt construction rules to better align future feature vectors and prompts with observed preferences.
Output: Updated model parameters and personalization settings that the server will use in subsequent runs to generate more accurate analysis result data, prompt sentences, and natural language recommendations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”

Conventional child-support and recommendation systems that propose play or educational activities based on behavioral information often rely on static rule sets or simple questionnaire scoring. Such systems typically treat user input as coarse, manually categorized attributes and do not fully exploit unstructured natural language descriptions provided by caregivers. As a result, these systems are limited in accuracy and adaptability, and they cannot adequately reflect the nuanced traits of each child or the changing context over time. Furthermore, known systems that employ machine learning or generative models are frequently architected as monolithic black boxes: they accept raw text input and return recommendations without a clear intermediate representation of child traits, recommendation context, or integration with curated internal activity data. This architecture presents multiple computer-technical drawbacks. First, it becomes difficult to reuse and incrementally improve intermediate analysis results, such as trait profiles, in downstream processes or across multiple sessions. Second, the lack of structured recommendation context makes it difficult to constrain or guide a generative AI model, causing unstable quality, redundant suggestions, and increased computational load due to unnecessarily long or unconstrained prompts.

Additionally, typical client-server implementations do not sufficiently separate responsibilities between terminals and servers in a way that optimizes network utilization and processing efficiency. In many cases, the terminal merely forwards raw text, and the server performs arbitrary, unstructured processing, which complicates scaling and makes it harder to efficiently store, retrieve, and update historical data. Moreover, conventional systems do not systematically combine deterministic rule-based recommendations from an internal activity catalog with probabilistic or generative outputs from an external generative AI model. This leads to inconsistent behavior, lack of traceability of recommendations, and difficulty in guaranteeing a minimum quality or safety level for suggested activities.
In the area of time-series use of historical data, many systems either ignore temporal changes in the child's traits or handle them in an ad hoc manner, such as overwriting prior data. Such approaches prevent a server from computing meaningful change indices or growth evaluations from a sequence of trait profiles. Consequently, the system cannot adjust recommendations in a principled way based on long-term evolution of the child's preferences and capabilities, which degrades the practical value of the system.
From the standpoint of human-computer interaction, existing systems also fail to adapt the presentation of recommendations to the emotional state of the user. Voice input, when used, is often handled only for command recognition and not for estimating the user's emotional condition. This omission means that report content and its ordering are not tuned to the user's current affective state, which can negatively impact user engagement and trust. There is a need to technically integrate voice-based emotion estimation with report generation and notification, in a way that is coherent with the underlying data processing pipeline.
Accordingly, there is a demand for an improved computer-implemented system architecture and processing method that: (i) structures user input into digital data suitable for systematic storage and analysis, (ii) applies natural language processing and machine learning to derive explicit child trait profiles, (iii) builds a recommendation context that constrains and guides a generative AI model via a prompt sentence, (iv) integrates generative proposals with an internal catalog of activities using tag matching and rule-based inference, (v) employs time-series analysis of stored trait profiles to compute change indices and longitudinal growth evaluations, and (vi) adapts report presentation based on emotion parameters estimated from user voice data. By addressing these issues as a computer-technical improvement, the invention aims to enhance processing efficiency, modularity, controllability of generative outputs, reuse of intermediate data structures, and user-adaptive presentation in a networked child-support recommendation system.

The specific processing by the specific processing unit 290 of the data processing device 12 in Example 2 is realized by the following means.

The present invention provides a server comprising a processor and a storage device, the processor being configured to control a terminal to accept user input describing behavior, interest, and activity of a child, to structure the input as digital data, and to receive the digital data from the terminal via a communication network; to store the received digital data in the storage device and to perform natural-language-based preprocessing on the digital data, including text normalization and feature extraction, in order to estimate, by using a machine learning model, a trait profile of the child; to generate recommendation context data including age information, interest information, weakness information, and derived tags on the basis of the trait profile and the digital data; to select, in accordance with the recommendation context data, candidate activity data relating to play and educational activity from an internal activity dataset by performing tag matching and rule-based inference; to generate prompt sentence data that summarizes the recommendation context data in a constrained and structured form, to transmit the prompt sentence data to an external generative AI model, and to acquire proposal content data returned from the generative AI model; to integrate the proposal content data with the candidate activity data so as to generate report data proposing play and educational activity suitable for the child in a structured format; and to convert the report data, by using a template engine, into display data for presentation to the user, to transmit notification data including access information to the display data to the terminal, and to control the terminal to obtain and output the display data. This enables a computer-implemented system to transform unstructured caregiver input into structured trait profiles and recommendation contexts, to guide a generative AI model with explicit prompt sentences that are constrained by internal activity data and rule-based logic, to efficiently generate reproducible and traceable recommendation reports, and to improve overall processing efficiency, modularity, and user-adaptive behavior in a network-based child activity recommendation environment.

The term “terminal” refers to an information processing apparatus operated by a user, such as a general-purpose computing device or communication device that includes an input interface, a display unit, and a communication function, and that transmits and receives data to and from a server via a communication network.

The term “server” refers to an information processing apparatus, or a group of such apparatuses, that provides a service over a communication network by executing programs, performing data storage and analysis, and responding to requests from one or more terminals.
The term “user” refers to a person or organization that operates a terminal to input information regarding a child and to receive and view report data or recommendations generated by the server.
The term “child” refers to a human minor for whom behavioral, interest, and activity information is collected and analyzed, and for whom play or educational activities are proposed.
The term “digital data” refers to information represented in a machine-readable format, including text data, numeric data, structured records, or encoded signals, which can be processed, stored, and transmitted by an information processing apparatus.
The term “communication network” refers to a wired or wireless data communication infrastructure, such as a local area network, a wide area network, or a public data network, that enables data transmission between a terminal and a server.
The term “storage device” refers to a hardware component or combination of hardware components, such as a memory device or a non-volatile storage subsystem, capable of storing digital data and program code for access by a processor.
The term “natural-language-based preprocessing” refers to a sequence of computational operations performed on text data, including at least one of tokenization, normalization, stop-word removal, stemming, lemmatization, or other linguistic analysis, to prepare the text data for feature extraction and machine learning.
The term “feature quantity” refers to a numerical representation derived from digital data, including but not limited to vectorized text features, statistical measures, or model-derived scores, which is used as input to a machine learning model.
The term “machine learning model” refers to a computational model trained on data to perform tasks such as classification, regression, clustering, or other predictive or inferential processing, and that takes feature quantities as input to produce output such as trait estimates or scores.
The term “trait profile” refers to structured data representing one or more inferred characteristics of a child, including strengths, weaknesses, preferences, or other attributes, which are estimated based on digital data and machine learning processing.
The term “recommendation context data” refers to structured data generated on the basis of a trait profile and digital data, the structured data including at least age information, interest information, weakness information, and one or more tags or indicators used to guide selection of candidate activities and generation of prompt sentence data.
The term “tag” refers to a label or keyword associated with digital data or activity data, used for classification, filtering, or matching in order to relate traits or interests of a child to candidate activities.
The term “internal activity dataset” refers to a collection of data records stored in a storage device, each record describing an activity, such as a play or educational activity, and including attributes such as applicable age range, tags, and descriptive information.
The term “candidate activity data” refers to one or more records selected from the internal activity dataset based on recommendation context data by processing such as tag matching and rule-based inference, and representing activities potentially suitable for a child.
The term “rule-based inference” refers to a data processing method in which one or more predetermined logical rules or conditions are applied to digital data, including tags and trait profiles, in order to select or rank candidate activities or to derive additional context.
The term “prompt sentence data” refers to text data constructed to be supplied as an input prompt to a generative AI model, the text data summarizing recommendation context data in a structured and constrained form to guide generation of proposal content.
The term “generative AI model” refers to a computational model that generates text or other data content in response to an input prompt, based on patterns learned from training data, and that can output proposals, explanations, or other natural-language content.
The term “proposal content data” refers to digital data, including natural-language text, generated by a generative AI model in response to prompt sentence data, and describing, for example, analysis, suggestions, or recommended activities.
The term “report data” refers to structured or semi-structured digital data that integrates candidate activity data and proposal content data, and that describes play or educational activities suitable for a child, optionally including trait summaries, reasons, and explanations.
The term “template engine” refers to software that combines a predefined template with dynamic data, such as report data, by replacing placeholders or tokens with actual values, thereby generating display data in a desired output format.
The term “display data” refers to digital data formatted for presentation on a display unit of a terminal, such as text, markup, or structured content, which can be rendered as a human-readable report or interface.
The term “notification data” refers to digital data transmitted from a server to a terminal to indicate availability of display data or a report, and including access information such as an identifier, a link, or metadata for retrieving the display data.
The term “display unit” refers to a hardware component of a terminal, such as a screen or other visual output device, configured to present display data in a form perceivable by a user.
The term “voice data” refers to digital representations of acoustic signals produced by a user, obtained through a sound input device such as a microphone and digitized for processing.
The term “voice analysis processing” refers to computational processing performed on voice data, including at least one of feature extraction, speech signal analysis, prosody analysis, or classification, to derive information such as emotion-related features.
The term “emotion parameter” refers to a numerical or categorical value derived from voice analysis processing that represents an estimated emotional state of a user, such as calm, stressed, or excited, and that is used to modify report presentation.
The term “time-series analysis processing” refers to computational techniques applied to data that vary over time, including one or more of trend detection, change detection, smoothing, or comparison across time points, to identify temporal patterns or changes.
The term “change index” refers to a quantitative or qualitative indicator derived from time-series analysis that represents variation or evolution of a child's trait profile over multiple time points.
The term “longitudinal growth evaluation” refers to an assessment, expressed as part of report data, of how a child's traits or abilities have changed or developed over time, based on comparison between current and past trait profiles.

According to one or more embodiments, a system includes at least one server and at least one terminal that are interconnected via a communication network. The terminal includes an input interface, a display unit, a memory, and a communication interface. The server includes a processor, a memory device, a non-volatile storage device, and a network interface. The server and the terminal each execute program modules stored in the respective memories so as to implement the functions described below.

The terminal is a general-purpose computing device such as a smartphone, a tablet, or a personal computer. The terminal executes application software, for example a native mobile application developed using an application framework or a web browser executing a client-side script framework. The terminal presents input fields, selection controls, and guidance messages on the display unit, and the user operates the terminal to input information regarding behavior, interest, and activity of a child. The terminal converts the user's input into structured digital data, such as a key-value record including child age, recent interests, strengths, weaknesses, and context notes, and the terminal transmits this digital data to the server via a secure communication protocol such as HTTPS.
The user operates the terminal to enter natural-language descriptions rather than selecting only predefined options. For example, the user may type:
“A 6-year-old boy likes building with wooden and plastic blocks, enjoys simple science experiments with water and baking soda, and often asks ‘why’ questions about nature. He quickly loses interest when reading long text-only books.”
The terminal encodes this description together with numeric age information and language information, then transmits it as digital data. By structuring the input at the terminal side (for example, separating fields such as “age”, “interests”, “strengths”, “weaknesses”), the terminal reduces ambiguity and packet size, thereby contributing to more efficient storage and lower communication overhead for the server.
The server receives the digital data from the terminal through the network interface and stores the received data in a storage device. The storage device may be a relational database system or a key-value store executing on one or more storage servers. The server maintains at least a first data structure for raw digital data (for example, a table or a document that stores a timestamp, a user identifier, a child identifier, and the natural-language input strings), and a second data structure for trait profiles (for example, a record that stores normalized scores and categorical labels representing multiple child traits).
The server applies natural-language-based preprocessing to the text fields in the digital data.
The server uses a natural language processing library, such as a text tokenization and normalization module, to perform operations including tokenization, lowercasing, punctuation removal, and lemmatization. The server uses a stop-word list to remove high-frequency, low-information words. The server then uses a feature extraction module to compute numerical representations of the processed text, for example using a term frequency-inverse document frequency (TF-IDF) vectorizer or a word-embedding-based encoder. In one embodiment, the server uses a feature vector of fixed dimension (for example, 300 or 768 dimensions) as a feature quantity that is used as input to a machine learning model.
The server uses a machine learning model to estimate a trait profile of the child from the feature quantity and other structured digital data such as age. In one embodiment, the server employs a neural network having multiple layers including an input layer corresponding to the feature quantity dimensions, one or more hidden layers having fully connected units with non-linear activation functions (for example, rectified linear units), and an output layer that produces trait scores for multiple trait categories such as creativity, logical thinking, social skills, attention span, and preference for physical activity. The server trains this neural network offline using supervised learning. During training, the server uses labeled training data that include feature quantities and ground-truth trait labels obtained from expert annotations or validated questionnaires. The server defines a loss function such as a cross-entropy loss for categorical outputs or a mean squared error for continuous trait scores. The server updates the weights of the neural network by performing gradient-based optimization, for example stochastic gradient descent or an adaptive optimization method. The server may apply regularization techniques such as dropout or weight decay to prevent overfitting. The server stores the trained weights in the storage device and loads them into memory when performing inference.
In another embodiment, the server uses a combination of a clustering algorithm and a classification algorithm. The server applies a clustering algorithm such as k-means or a Gaussian mixture model to assign the child to one of a finite number of trait clusters, and the server uses a classification algorithm such as a random forest or logistic regression to compute trait probabilities. The server combines the cluster index and trait probabilities to construct a trait profile record, which the server stores in the second data structure. By using such combined modeling, the server improves robustness and interpretability of trait estimation while maintaining computational efficiency.
The server generates recommendation context data based on the trait profile and the original digital data. The server creates a context record that includes at least age information, interest information, weakness information, and a set of tags that describe relevant aspects of the child, such as “blocks”, “science”, “hands-on”, “short attention span”, “reading difficulty”.
The server derives these tags from the digital data and the trait profile using rule-based mapping. For example, the server may define a rule that sets a “short attention span” tag if the attention span trait score is below a threshold, or a “hands-on” tag if the combination of creativity and curiosity traits exceeds a threshold and the input text contains words such as “experiment” or “build”.
The server maintains an internal activity dataset in the storage device. This dataset contains records, each representing a play or educational activity. Each activity record includes an activity identifier, a human-readable title, a description, a recommended age range, one or more tags, and optional metadata such as required materials or estimated duration. The server indexes the internal activity dataset by tags and age ranges. When the server generates recommendation context data for a child, the server selects candidate activity data by matching tags in the context record against tags in the activity records and by verifying that the child's age falls within the recommended age range of each activity. The server may use a ranking algorithm that counts tag overlaps and applies weights to different tags to compute a relevance score for each activity.
In addition to selecting candidate activities, the server generates prompt sentence data to be provided to a generative AI model. The server constructs the prompt sentence to summarize the recommendation context in a compact and structured natural-language form. For example, the server may generate a prompt sentence such as:
“A parent reports the following about their 6-year-old child: He loves building with blocks and simple science experiments using household items. He is very curious and frequently asks ‘why’ questions about nature, but he quickly loses interest when reading long text-only books. Based on this information, analyze his strengths and weaknesses and propose at least five specific play and educational activities that are suitable for his age. For each activity, explain briefly why it matches his interests and how it can support his development.”
The server may tailor the prompt sentence to include tags or trait labels explicitly, for example including phrases such as “high creativity”, “high curiosity”, or “short attention span” to guide the generative AI model. By controlling and structuring the prompt sentence in this manner, the server constrains the generative AI model to operate within a context already processed and filtered by the server, which improves stability, reduces irrelevant output, and reduces the length and complexity of the prompt data.
The server transmits the prompt sentence data to an external generative AI model via an application programming interface. The generative AI model may be implemented as a large-scale neural network language model trained on text corpora. The server configures parameters such as maximum output length and temperature when sending the request. The generative AI model receives the prompt sentence and computes an output sequence of tokens by performing operations such as multi-layer self-attention, feed-forward transformations, and softmax probability sampling in an auto-regressive manner. The server receives the generated natural-language text (proposal content data) from the generative AI model and parses it into structured units such as bullet lists of activities and associated explanations.
The server integrates the proposal content data with the candidate activity data obtained from the internal activity dataset. For example, if the generative AI model suggests an “outdoor nature scavenger hunt” activity, the server attempts to match this description against existing activity records using keyword matching, semantic similarity computation, or tag matching. If a match is found, the server links the suggestion to the corresponding internal record for consistency and traceability. If no direct match is found, the server may create a new temporary activity record or annotate the suggestion with derived tags. The server resolves duplicates and orders the final activity list according to relevance scores, trait coverage, diversity of activity types, or other criteria. As a result, the server generates report data that includes child trait summaries and a curated list of recommended activities, each with an explanation and, when applicable, a reference to an internal activity record.
The server converts the report data into display data by using a template engine. The server maintains at least one template that defines a structure for presenting trait summaries, key strengths, challenges, and recommended activities. The template includes placeholders for dynamic fields such as the child's age, trait labels, and activity descriptions. The server processes the template by substituting these placeholders with corresponding values from the report data. The server thereby generates display-ready content in a markup language or structured format suitable for rendering on the terminal. The server stores a copy of the report data and the display data in the storage device associated with a report identifier.
The server optionally acquires voice data from the user through the terminal. In such a case, the terminal captures the user's voice by a microphone, encodes it as digital audio data, and transmits the voice data to the server. The server performs voice analysis processing on the voice data, for example extracting acoustic features such as pitch, energy, and spectral characteristics, and computing emotion parameters using a trained classifier model. The server uses the emotion parameters to adjust the expression style or ordering of the report content, for example placing reassuring messages and simpler explanations earlier when the user appears stressed or anxious. This adjustment improves user engagement and comprehension while using specific acoustic features and classification thresholds in a manner that is not achievable by manual human-only processing at similar scale and speed.
The server applies time-series analysis processing to historical trait profiles for the child stored in the storage device. The server retrieves a sequence of past trait profiles associated with the same child identifier and compares the current trait profile with prior profiles. The server computes change indices, such as differences in trait scores, trend slopes, or moving averages. The server includes these change indices and an interpretation of longitudinal growth in the report data. For example, the server may note that the child's interest in reading has increased over six months while attention span has stabilized. This time-series analysis allows the server to adapt the selection and ranking of activities by emphasizing activities that support emerging strengths or address persistent challenges, thereby reducing trial-and-error and redundant recommendations.
The terminal receives notification data from the server indicating that display data for a new or updated report is available. The notification data includes a report identifier or a link that allows the terminal to request the display data. The terminal, upon user interaction with a notification or an application interface, requests the display data, receives it, and renders it on the display unit. The user then scrolls, reads, and optionally interacts with links to additional resources. For example, the report may contain an activity named “Build your own volcano experiment,” along with steps, required materials, and an explanation of how it supports curiosity and basic scientific thinking.
From a technical perspective, the described architecture improves computer technology in several ways. First, by structuring user input into digital data with explicit fields and by separating raw data, trait profiles, recommendation context data, and report data into distinct data structures, the server reduces coupling between modules and enables efficient indexing, caching, and re-use of intermediate results. This leads to reduced computational load when updating only some components (for example, re-generating a report without re-running full trait estimation), which improves throughput and decreases latency.
Second, by employing feature extraction and a specific neural network or hybrid machine learning architecture for trait estimation, the server automates a classification task in a manner that exceeds simple rule-based scoring, and the model can generalize to unseen descriptions. The explicit use of feature vectors, loss functions, and weight updates during training allows the server to achieve higher accuracy and consistency than manual or heuristic methods, while also permitting optimization of model size and complexity to suit hardware capacity, which improves inference speed and reduces energy consumption.
Third, by generating a structured prompt sentence that summarizes recommendation context data and by constraining the generative AI model with internal tags and rule-based inference, the server reduces the token length and entropy of the generative task, which improves the quality and determinism of the generative AI output and decreases required computation in the generative AI infrastructure. This is not mere automation of human writing but an optimization of machine-to-machine communication based on explicit context modeling. The server's use of tag-based filtering and rule-based inference before and after the generative step ensures that the generative AI model operates as a controlled component integrated into a deterministic pipeline.
Fourth, by performing time-series analysis on stored trait profiles, the server uses numerical algorithms to detect trends and changes over time, rather than simply overwriting older data. This creates new technical functionality in the system, enabling the server to calculate change indices and incorporate them into recommendation context data. As a result, the system can avoid redundant communication and computation by focusing on changes, and can reduce storage retrieval operations by using summarized temporal metrics.
Fifth, by incorporating voice analysis processing and emotion parameter computation, the server uses signal processing and classification to adapt the presentation layer in a data-driven manner, which is different from static user interfaces. This adaptation can reduce the number of user interactions needed to obtain useful information, thereby lowering network requests and processing overhead over time, and providing a more efficient human-computer interaction flow.
The system can be varied in implementation. In one embodiment, the server and the database reside in a single physical machine. In another embodiment, the server logic is distributed across multiple computing nodes, such as a front-end web server, an application server, and a separate database server. In yet another embodiment, some preprocessing or feature extraction tasks may be partially executed on the terminal to reduce bandwidth usage, with the server performing only higher-level trait estimation and report generation. The generative AI model may reside within the same data center as the server or may be provided by a remote service provider, as long as the server constructs and transmits prompt sentence data and receives proposal content data.
The user may interact through various kinds of terminals, including a dedicated application or a web-based interface. The server may support multiple languages and may select language-specific tokenization and preprocessing modules depending on a language parameter in the digital data. The internal activity dataset may be updated and curated independently of the generative AI model, allowing the system to maintain consistent and verified activities even when the generative AI model is updated or replaced.
By combining structured data processing, machine learning-based trait estimation, controlled generative AI prompting, rule-based integration with an internal dataset, time-series analysis, and emotion-adaptive presentation, the server and terminal cooperate to provide a technically improved computer system. This system not only automates a human task but redesigns the way unstructured caregiver input is transformed into actionable recommendations in a modular, efficient, and verifiable data-processing pipeline, thereby improving accuracy, processing speed, communication efficiency, and long-term adaptability of the child activity recommendation environment.

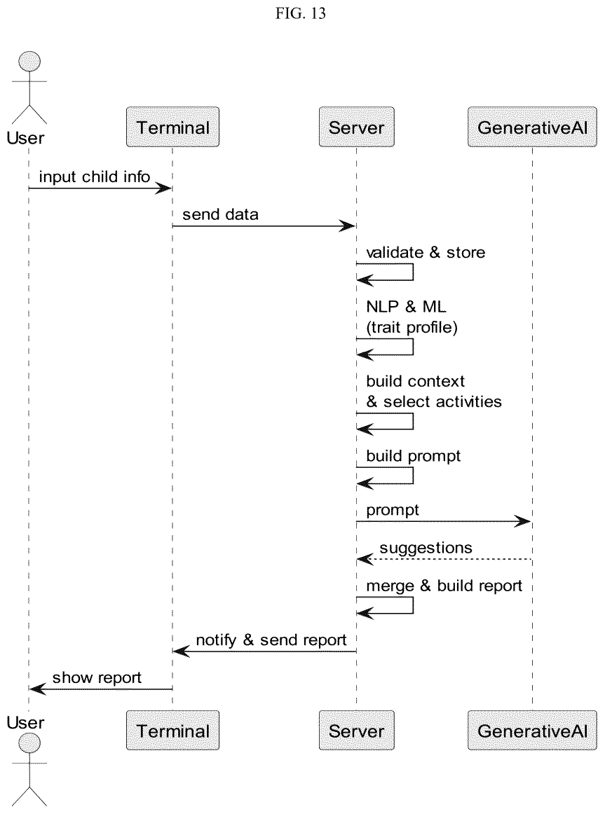

The following describes the processing flow using FIG. 13.

### Step 1:

The user operates the terminal to start a child-support application or web interface and to input information about a child. The input includes natural-language text describing behavior, interests, strengths, weaknesses, and context information such as age and language. The terminal receives this input through an input interface (for example, touch keyboard and selection controls). As input, the terminal obtains raw text strings and structured field values entered by the user. The terminal processes this input by separating it into predefined fields (for example, “age”, “recent_interests”, “strengths”, “weaknesses”) and by performing local validation such as checking that age is numeric and mandatory fields are not empty. As output, the terminal generates a structured data object that encodes the child information in a key-value format.

### Step 2:

The terminal transmits the structured child information to the server via a communication network. As input, the terminal uses the structured data object produced in Step 1. The terminal converts this object into a digital message, for example a JSON-formatted body, and embeds it into an HTTPS request addressed to a server endpoint. The terminal attaches metadata such as timestamps and authentication tokens. As data processing, the terminal serializes the structured data into a byte stream and uses a network communication stack to send the request. As output, the terminal produces a transmitted data packet that reaches the server and may also display a loading indicator to inform the user that processing is in progress.

### Step 3:

The server receives the transmitted digital message from the terminal and validates the content. As input, the server obtains the HTTPS request containing the structured child information. The server parses the request body to reconstruct the structured data object and checks field presence, data types, and permitted value ranges using validation rules. If errors are detected, the server generates an error response; if validation passes, the server proceeds. As data processing, the server maps the received fields into an internal data schema and assigns a unique identifier for the request and for the child. As output, the server produces a cleansed and validated digital data record, along with assigned identifiers, for further storage and analysis.

### Step 4:

The server stores the validated digital data into a storage device for later retrieval and time-series analysis. As input, the server uses the validated data record and the generated identifiers from Step 3. The server executes a data insertion operation, for example an SQL insert or an equivalent write operation to a storage system, and records fields such as age, free-text descriptions, timestamps, and user identifiers. As data processing, the server formats the record according to the schema of a child_behavior_log or similar structure and ensures transaction integrity. As output, the server produces a persistent stored record that can be addressed by a primary key or document identifier, and may return an internal log identifier for tracking.

### Step 5:

The server performs natural-language-based preprocessing on the text fields of the stored record. As input, the server retrieves the relevant text fields (for example, interests, strengths, weaknesses) from the validated data record or directly from storage. The server applies text processing algorithms such as tokenization, lowercasing, punctuation removal, stop-word elimination, and lemmatization. As data processing, the server converts sentences into lists of normalized tokens and then generates numerical features such as TF-IDF vectors or embeddings by computing term frequencies, inverse document frequencies, or by aggregating word embeddings. As output, the server generates one or more feature vectors representing the semantic content of the child-related descriptions in a fixed-dimensional numerical form.

### Step 6:

The server estimates a trait profile for the child using machine learning models. As input, the server uses the feature vectors from Step 5 together with structured attributes such as age and language. The server feeds these inputs into a trained neural network or a combined model (for example, clustering plus classification). As data processing, the server multiplies the input vectors by stored weight matrices, applies non-linear activation functions, and computes output scores for trait categories such as creativity, logical thinking, social skills, attention span, and activity preference. The server may also apply a clustering algorithm to assign a cluster label. As output, the server produces a trait profile data structure that includes trait scores, categorical labels, and optional cluster identifiers, and stores this profile in a separate trait_profile record associated with the child.

### Step 7:

The server generates recommendation context data by combining the trait profile with the original digital data. As input, the server uses the trait profile from Step 6 and the validated digital data from Step 3 or storage. The server derives tags and context fields such as age, key interests, and weaknesses by applying rule-based mappings and keyword detection. As data processing, the server compares trait scores to thresholds to set flags (for example, marking “short attention span” if an attention score is below a limit) and scans the text for domain-specific keywords (for example, “blocks”, “experiment”, “reading”). The server compiles these elements into a structured context record. As output, the server produces recommendation context data that contains age information, summarized interest and weakness descriptions, and a set of tags that will guide later selection of activities and generation of a prompt sentence.

### Step 8:

The server selects candidate activity data from an internal activity dataset using the recommendation context data. As input, the server uses the context record from Step 7 and an internal dataset of activity records stored in the storage device. The server filters activities by age range to ensure compatibility with the child's age and performs tag matching between context tags and activity tags. As data processing, the server computes a relevance score for each candidate activity based on tag overlap, weights assigned to particular tags, and optional constraints such as maximum number of activities per category. The server then sorts activities by score and selects a subset as candidate activity data. As output, the server generates a list of candidate activity records, each including identifiers, titles, descriptions, tags, and optional metadata, ready for integration with generative outputs.

### Step 9:

The server constructs a prompt sentence to be provided to a generative AI model based on the recommendation context. As input, the server uses the recommendation context data from Step 7, such as age, interests, weaknesses, trait labels, and tags. The server uses a text-generation routine to format this context into a coherent natural-language description that includes explicit instructions to the generative AI model. As data processing, the server concatenates sentences, inserts dynamic values (for example, age and key interests), and ensures that the prompt remains within predetermined length limits. For example, the server may generate:
“A parent reports the following about their 6-year-old child: He loves building with blocks and simple science experiments using household items. He is very curious and frequently asks ‘why’ questions about nature, but he quickly loses interest when reading long text-only books. Based on this information, analyze his strengths and weaknesses and propose at least five specific play and educational activities that are suitable for his age. For each activity, explain briefly why it matches his interests and how it can support his development.”
As output, the server produces prompt sentence data that summarize the context in a compact text form suitable for direct submission to the generative AI model.

### Step 10:

The server interacts with the generative AI model using the constructed prompt sentence. As input, the server uses the prompt sentence data from Step 9. The server embeds the prompt text into an API request to an external generative AI model service, specifying parameters such as response length and randomness control. As data processing, the server serializes the request, transmits it over the network, and then waits for the response. Upon receiving the response, the server parses the returned data to extract the generated text content. As output, the server obtains proposal content data, typically a textual description of trait analysis and multiple suggested activities with explanations, formatted as paragraphs or bullet-like segments.

### Step 11:

The server integrates the generative AI output with the candidate activity data to form comprehensive report content. As input, the server uses the proposal content data from Step 10 and the list of candidate activity records from Step 8. The server analyzes the generative text to identify segments corresponding to individual activities and their rationales, possibly using keyword extraction, simple parsing rules, or semantic similarity matching. As data processing, the server attempts to map each AI-suggested activity to an internal activity record by comparing names, keywords, and tags; if a match is found, the server links them and consolidates descriptions; if not, the server creates temporary structured entries for AI-only activities. The server removes duplicates and orders the final set according to relevance and diversity. As output, the server produces report data that include a structured trait summary, a list of recommended activities (with references to internal records where possible), and explanatory text derived from or aligned with the generative AI output.

### Step 12:

The server converts the report data into display data using a template engine and prepares it for delivery. As input, the server uses the structured report data from Step 11. The server selects an appropriate template and injects dynamic values such as child age, trait descriptions, and activity lists into placeholder fields in the template. As data processing, the server generates a formatted document (for example, HTML or another markup) that defines the layout, headings, and sections visible to the user. The server may also generate a compact summary for notification purposes. As output, the server produces display data ready for rendering on the terminal and stores this display data along with a report identifier in the storage device.

### Step 13:

The server notifies the terminal that the display data is available and manages retrieval. As input, the server uses the report identifier and possibly user contact information associated with the terminal. The server generates notification data containing at least the report identifier or an access link and transmits this notification to the terminal via a push notification mechanism or other messaging channel. As data processing, the server formats the notification payload according to the requirements of the notification service and records that the report is ready. As output, the server produces a delivered notification that causes the terminal to become aware that new report content can be retrieved.

### Step 14:

The terminal receives the notification and obtains the display data from the server. As input, the terminal uses the notification payload received from the server, which includes the report identifier or link. The terminal responds by issuing a request to the server to fetch the corresponding display data. As data processing, the terminal sends a network request, receives the formatted display document from the server, and decodes it into an internal representation suitable for rendering. As output, the terminal obtains the display data associated with the child's report.

### Step 15:

The terminal presents the report to the user on the display unit. As input, the terminal uses the display data acquired in Step 14. The terminal renders textual and structural elements such as headings, trait summaries, and activity lists on the screen, and may support scrolling, tapping, or other user interactions. As data processing, the terminal translates markup or structure from the display data into visual elements and arranges them according to layout rules. As output, the terminal produces visible content on the display unit, allowing the user to read the trait analysis, understand the recommended activities, and decide how to apply them in real-world child support and educational planning.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented child-support systems that recommend learning content or activities for children typically rely on static rule sets or simple content-based filters. Such systems do not effectively leverage heterogeneous input data, such as free-form text descriptions of behavior, sensor-acquired activity logs, and voice input reflecting a user's emotional state. As a result, the systems generate generic recommendations that are poorly adapted to the child's evolving characteristics and to the user's current cognitive and emotional context. Furthermore, existing systems that employ machine learning models or generative AI models often treat these models as isolated components, without an integrated mechanism for constructing structured prompt sentences from analyzed child data and user emotion parameters. This leads to sub-optimal use of computational resources, fragmented data processing pipelines, and difficulty in maintaining consistency and personalization across sessions.

In addition, known systems seldom incorporate a time-series analysis of past child behavior data into the generation of prompts for a generative AI model. Without such temporal analysis, the system cannot robustly capture trends or changes in the child's strengths, weaknesses, and interests over time, causing the generated reports to ignore important longitudinal patterns. Moreover, existing systems typically perform emotion analysis, if at all, as a separate, post-hoc process that does not directly influence the internal representation of the child profile or the structure and tone of the generative output. This separation reduces the technical effectiveness of emotion recognition and increases the computational overhead due to redundant processing steps.
Accordingly, there is a need for an improved computer-implemented system and processing architecture that: (i) systematically acquires and preprocesses multi-modal child-related information via a terminal, (ii) applies machine learning algorithms to extract feature values and analyze child characteristics, (iii) computes user emotion parameters from voice input via an integrated speech and emotion analysis pipeline, and (iv) automatically constructs and updates prompt sentences supplied to a generative AI model, including time-series-based changes in child characteristics. Such a system should improve the efficiency, accuracy, and adaptability of the overall computation, and thereby enhance the technical performance of the recommendation engine executed by the processor.

The specific processing by the specific processing unit 290 of the data processing device 12 in Application Example 2 is realized by the following means.

The present invention provides a server comprising a processor configured to receive, via a communication interface, information relating to behavior, interest, and activity of a child that has been input by a user through a terminal, to store the received information in a storage unit, to preprocess character information included in the received information to convert the character information into feature values, to apply a machine learning algorithm to the feature values to analyze characteristics of the child, to obtain voice information of the user and convert the voice information into character information by using a speech recognition component, to calculate at least one emotion parameter from the character information by using an emotion analysis component, to perform time-series analysis by accessing past information relating to behavior, interest, and activity of the child stored in the storage unit and comparing the past information with currently received information so as to calculate a change in the characteristics of the child, to generate, based on an analysis result of the characteristics of the child, the calculated change in the characteristics of the child, and the at least one emotion parameter, a structured prompt sentence for input to a generative AI model, to cause the generative AI model, by supplying the structured prompt sentence thereto, to generate report information including play or educational activity suitable for the child, to adjust an expression content or an emphasis item of the generated report information on the basis of the at least one emotion parameter, and to transmit the adjusted report information to the terminal in a format suitable for presentation to the user. This enables the computing system to integrate multi-modal child behavior data, longitudinal characteristic analysis, and user emotion parameters into a unified prompt-generation and generative-output pipeline, thereby improving the technical performance of the processor in generating personalized, temporally adaptive, and emotion-aware reports while reducing redundant processing and enhancing the overall efficiency and accuracy of the recommendation computations.

The term “processor” refers to a hardware or virtual computation unit that executes machine-readable instructions to perform data acquisition, preprocessing, analysis, prompt generation, generative model invocation, and communication control.

The term “terminal” refers to an information processing apparatus operated by a user, such as a portable device or a fixed device, that provides an input interface for child-related information and an output interface for report information.
The term “server” refers to an information processing apparatus, which may be implemented as one or more physical or virtual machines, that includes the processor, storage unit, and communication interface for executing the functions of the system.
The term “communication unit” refers to a hardware or software component configured to transmit and receive data between the terminal and the server via a wired or wireless communication network.
The term “storage unit” refers to a memory device or a combination of memory devices, including volatile and non-volatile storage, configured to store child-related information, user-related information, feature values, model parameters, prompt sentences, and generated report information.
The term “information relating to behavior, interest, and activity of a child” refers to data indicating actions, preferences, tendencies, or ongoing engagements of a child, including but not limited to textual logs, sensor readings, and contextual descriptions provided by a user.
The term “character information” refers to information represented as character strings, such as textual descriptions or transcribed speech content, that can be processed as natural language data.
The term “preprocessing” refers to a sequence of data transformation operations applied to raw information, including cleaning, normalization, tokenization, and conversion into numerical feature values suitable for machine-learning analysis.
The term “feature values” refers to numerical or categorical representations derived from raw data through preprocessing, which quantitatively express characteristics of the data and are used as inputs to machine-learning algorithms.
The term “machine learning algorithm” refers to a computational procedure that learns patterns from data, such as a classification, regression, or clustering method, and that outputs analysis results used to infer characteristics of the child.
The term “characteristics of the child” refers to inferred properties of the child, including strengths, weaknesses, preferences, aversions, and other behavioral or cognitive traits derived from analysis of child-related information.
The term “voice information of the user” refers to audio data representing speech uttered by the user, captured by a microphone or similar audio input device.
The term “speech recognition component” refers to a software or hardware module configured to convert voice information of the user into character information by recognizing spoken language content.
The term “emotion analysis component” refers to a software or hardware module configured to estimate an emotional state of the user from character information or other derived features, including but not limited to sentiment, anger, stress, or positivity.
The term “emotion parameter” refers to a quantitative indicator or set of indicators that numerically express an estimated emotional state of the user, and that are used to control generation and adjustment of report information.
The term “time-series analysis” refers to a computational process that analyzes chronological sequences of child-related information to detect trends, changes, or patterns in the characteristics of the child over time.
The term “change in the characteristics of the child” refers to a variation in the inferred properties of the child between different time points, identified by comparing past information with current information through time-series analysis.
The term “prompt sentence” refers to a structured natural-language instruction or query generated by the processor, which encodes child characteristics, temporal changes, and emotion parameters as input conditions for a generative AI model.
The term “generative AI model” refers to a machine-learning model configured to generate natural-language text or other content in response to a prompt sentence, based on patterns learned from training data.
The term “report information” refers to a data structure including natural-language text or equivalent content that describes recommended play or educational activities suitable for the child, optionally including explanations, priorities, and guidance for the user.
The term “expression content of the report information” refers to textual wording, tone, or style used in the report information to present recommendations and explanations to the user.
The term “emphasis item” refers to a portion or aspect of the report information, such as a particular recommendation, positive behavior, or caution, that is highlighted or de-emphasized relative to other portions based on emotion parameters.
The term “format suitable for presentation to the user” refers to a representation of the report information that can be displayed or rendered on the terminal, including layout, segmentation, and encoding appropriate for a user interface.

### A. Overall System Configuration

Server includes a processor, a main memory, a non-volatile storage device, and a network interface connected by an internal bus. Server may be implemented by a physical computer or a virtual machine executing on a cloud computing platform. Server executes an operating system and middleware including a web server component, a database management component, and an application runtime.
Terminal includes a processor, a memory, a display, an audio input/output device such as a microphone and speaker, and a communication interface. Terminal executes a client application or a web browser that provides a user interface for input and output of information.
Server and terminal communicate via a communication network using a secure protocol.
Server exposes an application programming interface (API) for receiving child-related information and delivering report information. Terminal accesses this API using an application-level protocol.

### B. Functional Modules on Server

Server implements multiple software modules executed by the processor. The modules include:
(1) an acquisition module configured to receive, via the communication interface, information relating to behavior, interest, and activity of a child input by the user through terminal;
(2) a storage module configured to store the received information in a storage unit, such as a relational database and a file system;
(3) a preprocessing module configured to convert character information into numerical feature values by cleaning, tokenizing, and vectorizing text;
(4) an analysis module configured to apply a machine-learning algorithm to the feature values to analyze characteristics of the child;
(5) a speech recognition module configured to convert voice information of the user into character information using an acoustic model and a language model;
(6) an emotion analysis module configured to calculate at least one emotion parameter from the character information;
(7) a time-series analysis module configured to access past child-related information and compare it with current information to calculate a change in the characteristics of the child;
(8) a prompt generation module configured to generate a structured prompt sentence for input to a generative AI model on the basis of the analysis result, the change in characteristics, and the emotion parameter;
(9) a generative output module configured to cause the generative AI model to generate report information including play or educational activity suitable for the child by supplying the prompt sentence to the generative AI model; and
(10) a presentation module configured to adjust an expression content or an emphasis item of the generated report information on the basis of the emotion parameter and to transmit the adjusted report information to terminal in a format suitable for presentation to the user.

### C. Data Structures and Storage

Server uses predetermined data structures to improve internal data management and computational efficiency.
Server stores child-related information in a relational database table including fields such as child identifier, timestamp, raw text content, derived feature vector identifier, and emotion parameter identifier. Server stores voice information in a binary storage area and stores a reference path in the database. Server maintains a characteristic profile table that records, for each child, numerical scores for a plurality of traits, such as subject interest scores, difficulty scores, and activity preference scores.
Server represents feature values as fixed-length vectors. For example, server uses a term-frequency-inverse-document-frequency (TF-IDF) representation of tokenized text or a distributed representation such as an embedding vector. Server stores these vectors as rows in a separate feature table or as serialized arrays inside the database. Server thereby reduces repeated computation and improves processing speed.
Server maintains model parameters for the machine-learning algorithm and generative AI model access configuration in the storage unit. Server stores configuration data for thresholds used to decide how strongly to adjust expression content based on the emotion parameter. By explicitly storing these parameters and configurations, server can update models and rules without changing basic program structure.

### D. Text Preprocessing and Feature Extraction

Server executes the preprocessing module when child-related character information is received or when analysis is triggered.
Server removes non-informative characters, normalizes case, and performs tokenization using a natural-language processing library. Server optionally performs stop-word removal, stemming, or lemmatization to consolidate word variants. Server then applies a vectorization algorithm, such as TF-IDF or a trained embedding model, to map the processed tokens to feature values. In one embodiment, server uses a vocabulary and weighting matrix stored in the storage unit to compute a dense vector for each input document.
Server uses these specific feature extraction steps to enable the machine-learning algorithm to operate on compact, numerically stable representations. This reduces memory consumption and accelerates downstream classification and regression computations on the processor. In contrast to a simple keyword matching system, server's feature extraction separates important contextual information and allows more accurate characterizations of child behavior.

### E. Analysis of Child Characteristics by Machine-Learning Algorithm

Server executes the analysis module to infer characteristics of the child.
Server applies a supervised machine-learning model, such as a neural network classifier or a gradient-boosted decision tree, to the feature values. In one embodiment, server uses a multi-layer neural network with an input layer corresponding to the feature dimension, one or more hidden layers with non-linear activation functions, and an output layer representing trait scores. Server stores learned weights and biases for this neural network in the storage unit.
Server computes, for each input feature vector, output scores corresponding to categories such as “mathematics interest,” “reading difficulty,” “social play preference,” and “physical activity preference.” Server interprets these scores as probabilities or normalized trait intensities. Server updates the characteristic profile table by storing the new scores alongside a timestamp.
Server trains the machine-learning model using historical labeled data. Server selects a loss function appropriate to the task, such as cross-entropy for classification or mean squared error for regression. Server performs weight updates by backpropagating the gradient of the loss function with respect to each parameter and applying an optimization algorithm such as stochastic gradient descent or an adaptive variant. Server may augment training data by perturbing text inputs or sampling additional examples to improve robustness.
By using these specific machine-learning structures and training procedures, server improves the accuracy of child characteristic estimation compared to simple rule-based classification. The neural network can model non-linear relationships between inputs and traits, resulting in lower prediction error and more reliable downstream recommendations.

### F. Speech Recognition and Emotion Analysis

User may input voice information through terminal. Terminal captures audio data via the microphone and transmits it to server.
Server executes the speech recognition module to convert audio waveforms into character information. Server may use an acoustic model implemented as a deep neural network that maps acoustic features, such as Mel-frequency cepstral coefficients, to phoneme or character sequences. Server further uses a language model, such as an n-gram model or a neural sequence model, to improve recognition accuracy. Server outputs recognized text representing the user's utterance.
Server then executes the emotion analysis module. Server converts the recognized text into features, such as sentiment polarity, intensity, and specific emotion indicators. Server may combine lexicon-based scores with outputs from a trained neural classifier. The neural classifier may receive an embedding of the recognized text and output scores for emotions such as anger, joy, and stress. Server represents these scores as emotion parameters and stores them in association with the corresponding user and child session.
Server uses explicit thresholds and weighting rules to determine how the emotion parameter will influence subsequent processing. This design allows deterministic control over the effect of emotion on the content and tone of the report, and ensures that processing is not a mere post-hoc overlay but a technically integrated part of the pipeline.

### G. Time-Series Analysis of Child Characteristics

Server executes the time-series analysis module to capture the evolution of child characteristics over time.
Server retrieves multiple entries of characteristic profile data for a given child from the database. Server orders these entries by timestamp and constructs one or more sequences of trait scores. Server applies a time-series algorithm, such as exponential smoothing, moving average, or autoregressive modeling, to estimate trends and changes in each trait.
Server computes, for example, a rate of change in mathematics interest or a trend in reading difficulty. Server may classify changes as “improvement,” “deterioration,” or “stable” based on numerical thresholds. Server records the calculated change in characteristics in the database. Server later uses these temporal indicators as part of the input to the prompt generation module.
By explicitly modeling temporal dynamics, server allows the generative AI model to produce reports that are responsive not only to current status but also to improvement or decline patterns. This yields more technically meaningful personalization and reduces the risk of contradictory or stale recommendations.

### H. Prompt Generation for the Generative AI Model

Server executes the prompt generation module to construct a prompt sentence for the generative AI model.
Server collects the latest characteristic profile for the child, the calculated change in characteristics, and the emotion parameter. Server then constructs a structured natural-language text that encodes these elements in a consistent format. Server may apply a template that includes sections such as child age, strengths, weaknesses, current issues, temporal trends, and user emotion summary.
For example, server may generate the following prompt sentence for a learning plan:
“You are a generative AI model that creates personalized learning plans for children. Child: 8 years old. Strengths: arithmetic, sports. Weaknesses: math word problems, long reading tasks. Interests: dinosaurs, outdoor play.
Recent trend: mathematics interest has increased, but performance on word problems remains below average over the last four weeks.
Parent emotion: anger_score=0.80, stress_level=0.75, positivity_score=0.20 (the parent is angry and tired).
Please propose a one-week learning plan that improves math word-problem skills using short, enjoyable activities, and that reduces the parent's burden. Use calm and encouraging language.”
In another embodiment, server may generate a prompt sentence for product recommendations in a physical store:
“You are a generative AI model that explains product recommendations for parents. Child: 6 years old, very interested in dinosaurs, easily distracted by long tasks.
Recent trend: interest in reading time has slightly increased over the last two weeks.
Parent emotion: the parent is stressed and tired.
Candidate products: (1) dinosaur picture book (short, many illustrations), (2) complex dinosaur model kit (requires long concentration), (3) simple dinosaur craft kit (about 30 minutes).
Please recommend 2 products and briefly explain why they are suitable, focusing on reducing the parent's burden.”
Server thereby uses a non-conventional prompt construction procedure. Instead of passing raw user input directly to the generative AI model, server performs structured feature extraction, temporal analysis, and emotion quantification before embedding results in the prompt sentence. This improves the relevance and coherence of generated output and reduces token redundancy, which in turn reduces communication payload and processing time on the generative AI model service.

### I. Generative AI Model Interaction and Report Generation

Server executes the generative output module to obtain report information from the generative AI model.
Server sends the prompt sentence to an external or internal generative AI model interface.
The generative AI model may be implemented as a transformer-based neural network with multiple attention layers, trained on large-scale text corpora. The model receives the prompt sentence as input tokens and produces an output token sequence representing a natural-language report.
Server controls model parameters such as maximum output length and sampling temperature when requesting generation. Server receives the generated text and stores it in the storage unit as draft report information. Because the prompt sentence encodes both trait analysis and temporal changes, the generative AI model can generate content that references improvements, declines, or stable areas in the child's behavior and learning.
Server distinguishes this processing from manual authoring or simple rule templates by relying on the learned sequence modeling capabilities of the transformer architecture. The model computes self-attention across the prompt sentence, weighting different parts of the child profile and emotion summary according to learned patterns, which human operators cannot feasibly reproduce at scale or speed.

### J. Adjustment of Expression Content and Emphasis Based on Emotion Parameter

Server executes the presentation module to adjust the draft report according to the emotion parameter.
Server first analyzes the draft report content using pattern-matching rules or an auxiliary classifier to identify segments such as “praise,” “criticism,” or “recommendation.” Server then applies weighting rules derived from the emotion parameter. For example, when an anger score exceeds a threshold, server increases the relative proportion of praise statements and reduces direct criticism. Server may request a secondary generative refinement by constructing another prompt sentence including the draft report and emotion summary, instructing the generative AI model to rewrite content while preserving recommendations but changing tone.
An example of such a refinement prompt sentence is:
“You are a generative AI model that rewrites support reports for parents.
Draft report: [draft report text].
Parent emotion: the parent is angry and tired (anger_score=0.80, stress_level=0.75).
Please rewrite the report to keep the same recommendations but to emphasize the child's positive behaviors and recent successes, and to use calm, empathetic, and reassuring language. Avoid blaming the parent or the child.”
Server receives the refined text and replaces or augments the draft report. By explicitly coupling emotion parameters to generation and refinement, server ensures that the generative processing is not a generic text generation but a technically constrained transformation driven by quantified emotional metrics. This leads to reduced risk of generating emotionally inappropriate content and improves user acceptance, thereby reducing repetitive interactions and network traffic.

### K. Output to Terminal and User Interaction

Server transmits the final report information to terminal via the communication interface.
Terminal receives a structured payload containing report text, optional product recommendations, and metadata such as timestamps and identifiers. Terminal formats the content for display using a presentation layer. Terminal may highlight emphasis items indicated by server, such as key recommended actions or positive behaviors.
User reads the report on terminal. User may select certain suggested activities or products, or may provide feedback that is transmitted back to server. Server uses this feedback to update characteristic profiles and refine models over time, thereby creating a closed loop of computational improvement.

### L. Technical Effects and Improvement of Computer Technology

Server improves computer technology in several ways.
Server reduces overall computation time and network load by separating heavy model training from runtime inference and by reusing stored feature values and characteristic profiles. Server employs structured prompt generation to minimize redundant context tokens, which reduces the number of tokens processed by the generative AI model and improves throughput.
Server improves accuracy and robustness of child characteristic estimation by using specific feature extraction, neural network architectures, and time-series algorithms. The combination of static trait scores and temporal trends allows server to generate more consistent and predictive recommendations, reducing the need for repeated corrections and manual adjustments.
Server enhances data management by organizing heterogeneous data (text, audio, traits, emotion parameters, and temporal trends) into coordinated data structures. This structured storage allows efficient querying and modification, which contributes to faster response times and better scalability.
Server executes non-conventional processing steps that differ from mere automation of human tasks. Human users typically do not compute TF-IDF vectors, train neural networks, quantify emotion parameters, or conduct formal time-series analysis before deciding on activities for a child. Server, by contrast, performs these algorithmic steps systematically and integrates their outputs into machine-interpretable prompt sentences. This constitutes an improvement in the functioning of the computer system itself, in terms of processing pipeline design, computational efficiency, and overall quality of generated outputs.

### M. Alternative Embodiments and Variations

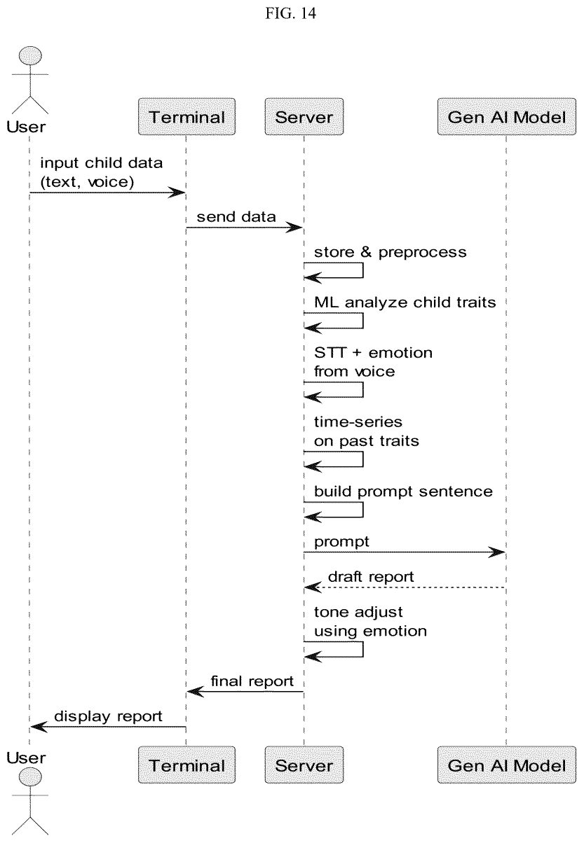

Server may employ alternative machine-learning models, such as recurrent neural networks or convolutional architectures, for analysis of child behavior text. Server may also use different vectorization methods, such as contextual embeddings that take sentence-level context into account. Server may adapt the loss function or training regimen to optimize for different application metrics, such as recall of risk indicators or precision of activity suitability.
Server may perform emotion analysis using multimodal features, combining textual sentiment with acoustic features such as pitch and speech rate. Server may use a joint model that simultaneously infers emotion and user cognitive load. Server may further adjust communication scheduling, such as deferring non-urgent notifications when stress is high, thereby reducing cognitive burden and improving practical usability.
Server may host the generative AI model locally or access it through a remote service. Server may modify the prompt structure to target different kinds of outputs, such as brief summaries, long-form reports, or structured action lists. In all cases, server maintains the use of feature- and trend-based child characterization and quantified emotion parameters when constructing the prompt sentence.
Server and terminal may be integrated into different hardware configurations, such as embedded controllers in educational devices or in-store kiosks. In such embodiments, server may additionally control peripheral devices or user-interface hardware, further coupling the computational processing with physical device behavior.
Through these embodiments and variants, server, terminal, and user cooperate to realize a system in which the processor executes specific data transformations, machine-learning computations, and generative interactions that improve the technical operation of the computing environment and enable accurate, efficient, and adaptive generation of child-related report information.
The following describes the processing flow using FIG. 14.

### Step 1:

User operates the terminal to input child-related information.
User opens an application on the terminal and types textual descriptions of the child's behavior, interest, and activity (for example, “He likes math but struggles with word problems and prefers outdoor play.”).
User optionally records voice comments about the child and about the user's own feelings (for example, “I am very tired and frustrated about homework time.”) using the microphone of the terminal.
Input: free-form text fields and recorded audio data provided by the user.
Output: a structured data object inside the terminal containing child identifiers, timestamps, textual descriptions, and audio data references.

### Step 2:

Terminal converts local inputs into a structured request and sends it to the server.
Terminal encapsulates the text and metadata (child identifier, user identifier, timestamp) into a message structure, and associates the recorded audio file or audio stream with this message.
Terminal establishes a secure communication channel and transmits the structured message to the server.
Input: the structured data object produced in Step 1.
Output: a network request delivered to the server including child-related text data and voice data for processing.

### Step 3:

Server receives and validates the incoming request.
Server parses the received message, verifies that mandatory fields such as child identifier and timestamp are present, and checks user authentication data.
Server rejects malformed or unauthorized requests and accepts valid requests for further processing.
Input: the network request from the terminal containing raw text, audio data, and metadata.
Output: validated raw data stored temporarily in server memory, ready for storage and analysis.

### Step 4:

Server stores raw data and prepares analysis records.
Server writes the textual descriptions, metadata, and references to audio data into persistent storage structures such as database tables and file storage.
Server assigns internal identifiers to each new record to allow later retrieval by child and by session.
Input: validated raw text, audio data, and metadata held in server memory from Step 3.
Output: persistent records containing child-related text entries and voice references, indexed by identifiers and timestamps.

### Step 5:

Server preprocesses the child-related text data and extracts feature values.
Server reads the raw text entries from storage, removes unnecessary characters, normalizes case, and tokenizes each sentence into words or sub-words.
Server applies a vectorization algorithm to convert the sequence of tokens into numerical feature values, such as TF-IDF vectors or embedding vectors, which represent the semantic content of the text.
Input: stored raw text records associated with a child and a session.
Output: numerical feature vectors representing the processed text, plus associated record identifiers.

### Step 6:

Server analyzes child characteristics using a machine-learning algorithm.
Server loads a pre-trained model, applies the numerical feature vectors as inputs, and computes output scores representing traits such as subject interests, difficulties, and activity preferences.
Server maps the output scores to a standardized characteristic profile and stores this profile in association with the child.
Input: the feature vectors produced in Step 5 and model parameters stored on the server.
Output: a child characteristic profile including numerical trait scores and qualitative labels (for example, “high interest in math,” “low skill in word problems,” “high outdoor activity preference”).

### Step 7:

Server converts user voice input into text.
Server retrieves the stored audio data referenced in the session and passes the audio waveform to a speech recognition component.
Server processes the audio through acoustic and language models to generate a transcript representing the user's spoken comments.
Input: recorded audio data of the user's speech from Step 4.
Output: recognized user speech as character information suitable for further analysis.

### Step 8:

Server calculates emotion parameters from the recognized user text.
Server applies an emotion analysis component that transforms the recognized text into emotion-related features and computes emotion parameters such as anger score, stress level, and positivity score.
Server stores these emotion parameters as part of the session record linked to the user and child identifiers.
Input: the recognized text produced in Step 7.
Output: a set of numerical emotion parameters characterizing the user's emotional state during the input session.

### Step 9:

Server performs time-series analysis of child characteristics.
Server retrieves multiple past characteristic profiles of the same child and orders them by timestamp.
Server compares the current profile with earlier profiles using a time-series algorithm to calculate trends and changes in each trait, such as increasing interest or decreasing difficulty.
Input: the current characteristic profile from Step 6 and historical characteristic profiles from storage.
Output: temporal change indicators for each trait, including direction and magnitude of change (for example, “math interest increasing,” “reading difficulty stable”).

### Step 10:

Server generates a structured prompt sentence for the generative AI model.
Server collects the current characteristic profile, the temporal change indicators, and the emotion parameters, and embeds these values into a structured natural-language description.
Server composes a prompt sentence that instructs the generative AI model to generate a report, including constraints on length, tone, and focus, based on the child's traits and the user's emotional state.
Input: the characteristic profile from Step 6, the temporal change indicators from Step 9, and the emotion parameters from Step 8.
Output: a prompt sentence ready to be supplied as input to the generative AI model.

### Step 11:

Server sends the prompt sentence to the generative AI model and receives a draft report.
Server transmits the prompt sentence to a generative AI model interface, specifying generation parameters such as maximum token length and sampling temperature.
Server receives the generated text that describes recommended play or educational activities tailored to the child, and stores this text as draft report information.
Input: the prompt sentence prepared in Step 10.
Output: draft report text generated by the generative AI model, stored in association with the session.

### Step 12:

Server adjusts the draft report according to the emotion parameters.
Server examines the draft report text together with the previously computed emotion parameters and applies predetermined rules or an additional generative refinement step to modify the expression content and emphasized items.
Server increases, reduces, or rephrases certain sections to align with the user's emotional state, such as emphasizing positive behaviors when anger is high, and then finalizes the report.
Input: the draft report text from Step 11 and the emotion parameters from Step 8.
Output: an adjusted final report text that preserves core recommendations while adapting tone and emphasis to the user's emotions.

### Step 13:

Server formats the final report for presentation and sends it to the terminal.
Server encapsulates the final report text and associated metadata into a response structure and converts it into a format that the terminal can render, such as a structured document with sections for strengths, weaknesses, and recommended activities.
Server transmits the formatted report to the terminal through the communication interface.
Input: the final adjusted report text from Step 12.
Output: a response message containing formatted report information delivered to the terminal.

### Step 14:

Terminal presents the report to the user.
Terminal receives the response message from the server, parses the formatted content, and displays the report on the screen using headings, bullet points, and emphasis markers as indicated by the server.
Terminal optionally allows the user to scroll, expand sections, or mark certain recommendations as completed or favored for feedback to the server.
Input: the formatted report information from Step 13.
Output: a visual representation of the report on the terminal display and, optionally, user interaction events that may be sent back to the server for future processing.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

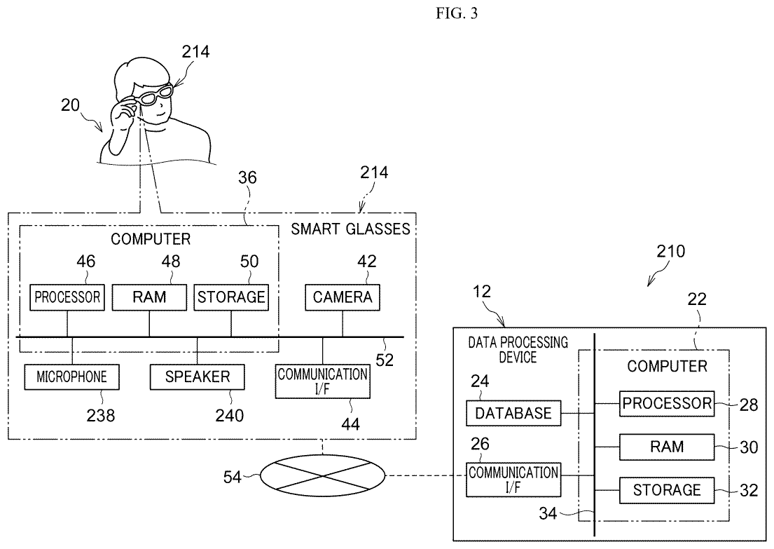

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

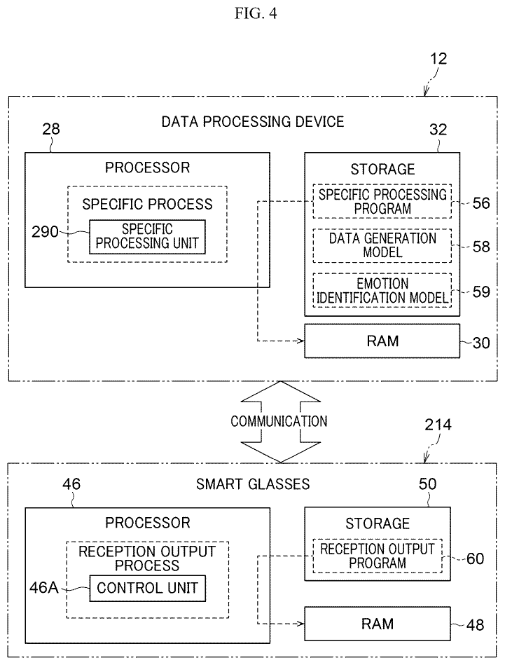

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

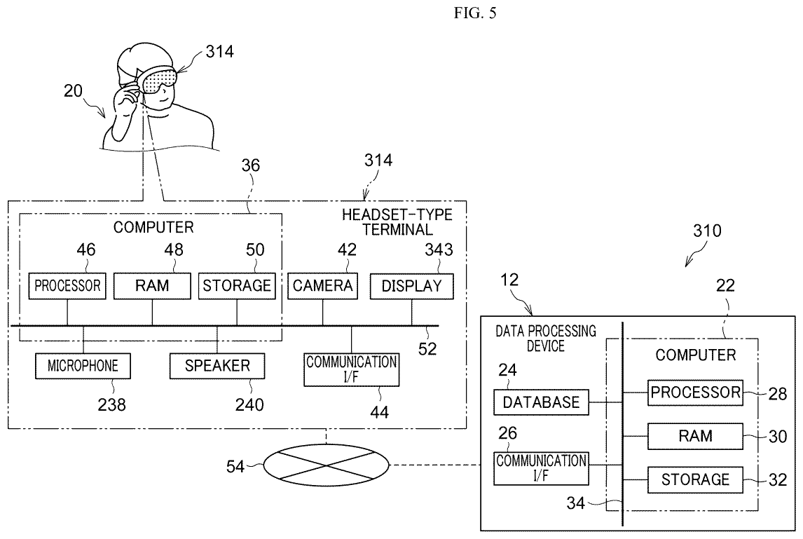

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

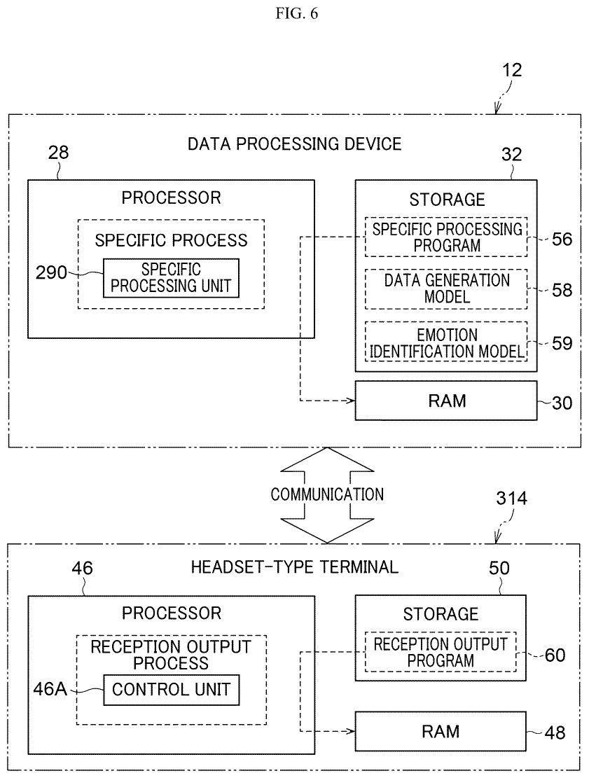

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

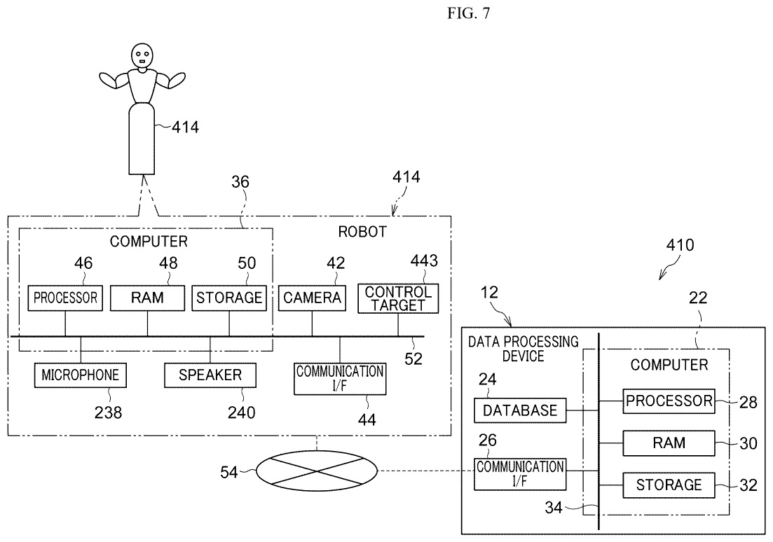

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

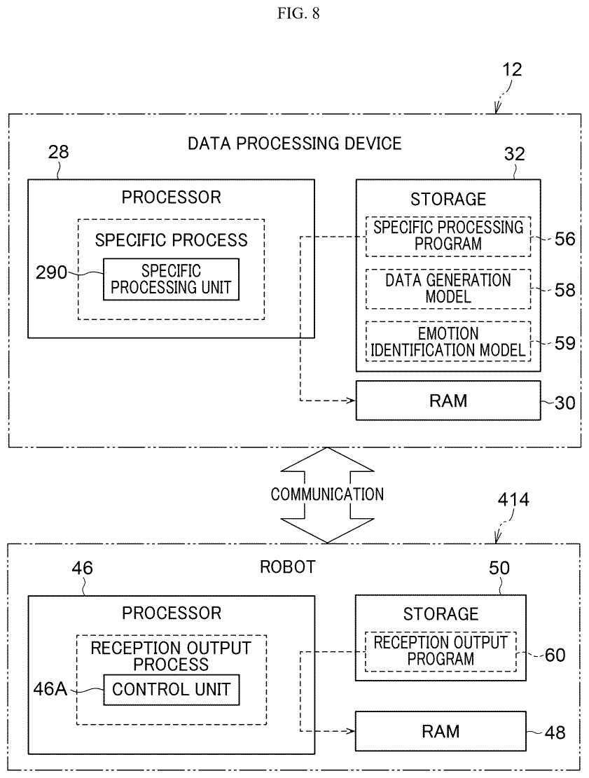

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

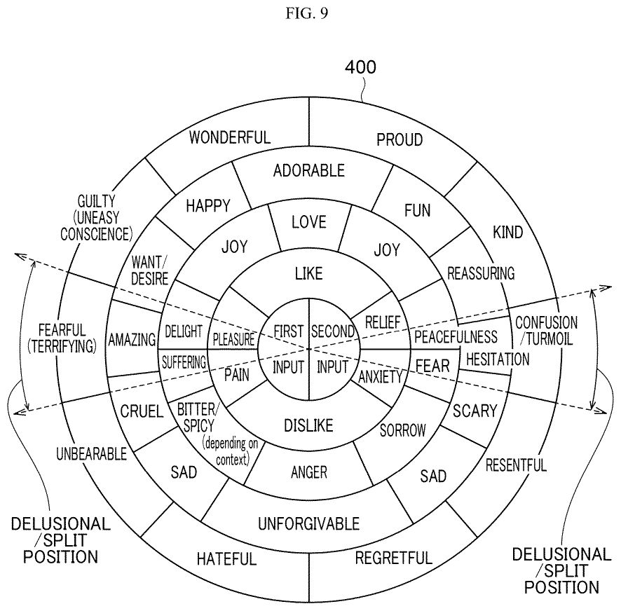

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

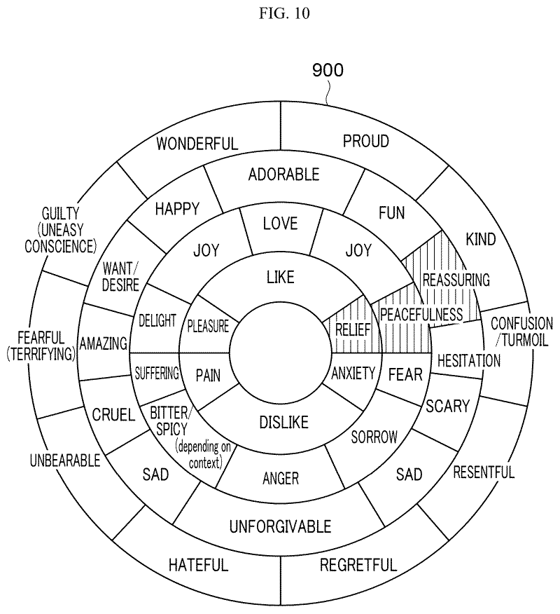

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication network, descriptive information regarding behavior, interests, and activities of a child from an information processing terminal operated by a user, convert the descriptive information into a predetermined data structure, and store the converted descriptive information in a storage device,
perform preprocessing on the stored descriptive information by using a character string processing program, the preprocessing including at least normalization, segmentation, and removal of unnecessary terms, generate feature data by converting the preprocessed descriptive information into a numerical representation by using a natural language processing model, and analyze the feature data by using a machine learning model including at least one of a statistical learning model and a neural network model to calculate characteristic information indicating interest domains and learning tendencies of the child, select activity information representing play and educational activities suitable for the child by applying at least one of a rule set and a recommendation model to the characteristic information, and generate analysis result data including the activity information and the characteristic information,
execute a prompt generation process based on the analysis result data to construct a prompt sentence for input to a generative artificial intelligence model, and generate the prompt sentence described in a natural language and including an instruction content based on the characteristic information and the activity information,
input the prompt sentence to the generative artificial intelligence model disposed externally or internally, acquire a response sentence from the generative artificial intelligence model as an analysis report, store the analysis report in the storage device, and format the analysis report as notification data that is transmittable to the information processing terminal, and transmit the notification data to the information processing terminal, and cause the analysis report to be displayed on the information processing terminal so as to present information for proposing the play or the educational activities suitable for the child to the user.

### (Supplementary 2)

The system according to supplementary 1,
wherein the processor is configured to
acquire, from the information processing terminal, at least one of evaluation information regarding the analysis report and activity execution result information regarding execution of the play or the educational activities by the child, accumulate the evaluation information or the activity execution result information as history data in the storage device, and update training data for at least one of the machine learning model and the recommendation model based on the history data to perform a learning process that sequentially improves accuracy of calculation of the characteristic information and extraction of the activity information.

### (Supplementary 3)

The system according to supplementary 1,
wherein the processor is configured to
access descriptive information and the characteristic information stored in the storage device for a plurality of time points, extract change patterns of the interest domains and the learning tendencies of the child by performing time-series analysis processing on the descriptive information and the characteristic information, and adjust at least one of contents of the prompt sentence and contents of the analysis report based on a temporal analysis result including the change patterns.

### Application Example 1

### (Supplementary 1)

A system comprising a processor,
wherein the processor is configured to
receive, via a communication interface, structured data including information on behavior, interest, and activity of a child, the structured data being input by a user through a terminal device,
preprocess, by execution of a program, the structured data using a natural language processing algorithm and a statistical learning algorithm, convert text information and attribute information included in the structured data into numerical vectors to generate feature data, and calculate analysis result data indicating characteristics and interest tendencies of the child on the basis of the feature data,
generate, on the basis of the analysis result data, prompt generation data by summarizing age, target of interest, behavior history, and activity history of the child using a template generation algorithm and constructing a prompt sentence including the summarized contents, transmit generation request data including the prompt generation data to a generative artificial intelligence model provided internally or externally to the system so as to cause the generative artificial intelligence model to generate natural language recommendation data relating to at least one of a play, an educational activity, and an article suitable for the child, and acquire the natural language recommendation data as a response from the generative artificial intelligence model,
associate the natural language recommendation data with candidate content information stored in an information storage device, generate report data indicating at least one of a play, an educational activity, and an article suitable for the child, and generate output data for transmitting the report data to the terminal device,
receive, from the terminal device, operation history data indicating at least one of viewing, selecting, purchasing, and participating operations performed by the user with respect to the report data displayed by the terminal device,
and update, using the operation history data, a learning model used for the generation of the feature data and the calculation of the analysis result data so as to generate learning update data configured to personalize, for each child, the prompt sentence and the natural language recommendation data to be generated in subsequent processing.

### (Supplementary 2)

The system according to supplementary 1,
wherein the processor is configured to
analyze voice data acquired from the user by a voice analysis algorithm, calculate an emotion parameter indicating an emotional state of the user, generate control data for dynamically changing at least one of a writing style, a level of detail, and a presentation order of the natural language recommendation data in accordance with the emotion parameter by modifying the prompt sentence and the report data, and transmit the control data to the terminal device.

### (Supplementary 3)

The system according to supplementary 1,
wherein the processor is configured to
access historical structured data and historical analysis result data on children stored in a history information storage device, compare current feature data with past feature data by using a time series analysis algorithm to calculate a characteristic change index of the child, and generate time series evaluation data for reflecting the characteristic change index in the prompt sentence and in the natural language recommendation data.

### Example 2

### (Supplementary 1)

A system comprising a processor,
wherein the processor is configured to
control a terminal to allow a user to input information regarding behavior, interest, and activity of a child, to structure the input information as digital data, and to transmit the digital data via a communication network,
receive, by a server, the digital data transmitted from the terminal, store the digital data in a storage device, perform preprocessing based on natural language processing on the digital data, extract a feature quantity from text data obtained by the preprocessing, and estimate a trait profile of the child by using a machine learning model on the basis of the feature quantity,
generate, by the server, recommendation context data including age information, interest information, and weakness information on the basis of the trait profile and the digital data, extract, in accordance with the recommendation context data, candidate activity data relating to play and educational activity from an internal group of activity candidate data by tag matching and rule-based inference, generate prompt sentence data summarizing the recommendation context data, transmit the prompt sentence data to an external generative AI model, acquire proposal content data as a response from the generative AI model, and generate report data proposing play and educational activity suitable for the child by integrating the proposal content data with the candidate activity data, and
convert, by the server, the report data into display data viewable by a human by using a template engine, transmit notification data including access information to the display data to the terminal, and control the terminal to acquire the display data on the basis of the notification data and output the display data to a display unit.

### (Supplementary 2)

The system according to supplementary 1,
wherein the processor is configured to
acquire voice data of the user by the server, perform voice analysis processing on the voice data to calculate an emotion parameter, adjust an expression content or a presentation order of the report data according to the emotion parameter, and notify the terminal of the adjusted report data.

### (Supplementary 3)

The system according to supplementary 1,
wherein the processor is configured to
apply time-series analysis processing to past digital data and past trait profiles stored in the storage device by the server, extract a change index of a trait of the child by comparing a current trait profile with the past trait profiles, and reflect the change index in the recommendation context data so as to generate the report data including an evaluation of longitudinal growth and an activity proposal.

### Application Example 2

### (Supplementary 1)

A system comprising a processor,
wherein the processor is configured to
acquire, via a terminal, information relating to behavior, interest, and activity of a child input by a user, and transmit the acquired information to a server through a communication unit, store, in a storage unit of the server, the acquired information, perform preprocessing on character information included in the acquired information to convert the character information into feature values, and apply a machine learning algorithm to the feature values to analyze characteristics of the child,
generate, based on an analysis result of the characteristics of the child and information relating to emotion of the user, a prompt sentence for input to a generative AI model, cause the generative AI model to generate report information including play or educational activity suitable for the child by inputting the prompt sentence to the generative AI model, and
transmit the report information to the terminal and cause the terminal to convert the report information into a format presentable to the user and to notify the user of the report information.

### (Supplementary 2)

The system according to supplementary 1,
wherein the processor is configured to
convert voice information of the user into character information by using a voice recognition unit, calculate an emotion parameter from the character information by using an emotion analysis unit, and adjust an expression content or an emphasized item of the report information generated by the generative AI model on the basis of the emotion parameter before transmitting the report information to the terminal.

### (Supplementary 3)

The system according to supplementary 1,
wherein the processor is configured to
access past information relating to behavior, interest, and activity of the child stored in the storage unit, perform time-series analysis to compare the past information with currently acquired information and calculate a change in the characteristics of the child, and include a result of the calculation in the prompt sentence generated for input to the generative AI model so that content of the report information is automatically updated in accordance with a temporal trend of the child.

What is claimed is:

1. A system comprising:
circuitry configured to:
receive, via a communication interface, structured data comprising information on behavior, interest, and activity of a subject input by a user through a terminal device;
preprocess the structured data using a natural language processing algorithm and a statistical learning algorithm to convert text information and attribute information into feature data represented as numerical vectors;
calculate analysis result data indicating characteristics and interest tendencies of the subject from the feature data;
generate prompt generation data by summarizing age, target of interest, behavior history, and activity history of the subject according to a template generation algorithm and constructing a prompt sentence comprising the summarized contents;
transmit generation request data comprising the prompt generation data to a generative artificial intelligence model to cause the generative artificial intelligence model to generate natural language recommendation data relating to at least one of an activity and an article suitable for the subject, and acquire the natural language recommendation data;
associate the natural language recommendation data with candidate content information stored in a storage device to generate report data and output the report data to the terminal device; and
receive operation history data from the terminal device and update a learning model used for generation of the feature data and calculation of the analysis result data using the operation history data to generate learning update data configured to personalize the prompt sentence and the natural language recommendation data in subsequent processing.

2. The system of claim 1, wherein the circuitry is configured to:
apply an emotion recognition algorithm to at least one of the structured data and input information from the user through the terminal device to determine an emotional state of the user; and
adjust at least one of the prompt sentence and the natural language recommendation data based on the determined emotional state.

3. The system of claim 2, wherein the emotion recognition algorithm applies at least one of a lexicon-based scoring algorithm and a transformer-based sentiment classifier to text expressions in the input information to generate an emotional state category comprising at least one of a positive state, a negative state, a neutral state, and a stressed state.

4. The system of claim 3, wherein adjusting the prompt sentence based on the emotional state comprises incorporating an emotional state instruction token into the prompt generation data that directs the generative artificial intelligence model to generate the natural language recommendation data in a tone and content emphasis corresponding to the emotional state category.

5. The system of claim 4, wherein the circuitry is configured to:
perform time-series analysis on past structured data for the subject stored in the storage device to identify temporal trends in the characteristics and interest tendencies; and
incorporate the identified temporal trends into the analysis result data for use in constructing the prompt sentence.

6. The system of claim 1, wherein preprocessing the structured data using the natural language processing algorithm comprises applying at least one of tokenization, morphological analysis, and named-entity extraction to the text information to generate text feature tokens.

7. The system of claim 6, wherein preprocessing the structured data using the statistical learning algorithm comprises applying at least one of a feature hashing algorithm and an embedding algorithm to convert the text feature tokens and the attribute information into the numerical vectors.

8. The system of claim 1, wherein calculating the analysis result data comprises applying a trained classification model to the numerical vectors to generate probability distributions over a predefined set of characteristic categories and interest tendency categories.

9. The system of claim 8, wherein the trained classification model applies a transformer-based architecture or a gradient boosting algorithm to the numerical vectors to compute the probability distributions.

10. The system of claim 1, wherein the template generation algorithm constructs the prompt sentence by serializing the age, the target of interest, the behavior history, and the activity history of the subject into a structured prompt template that specifies an output format constraint and instructs the generative artificial intelligence model to generate the natural language recommendation data scoped to the subject's characteristics.

11. The system of claim 10, wherein the structured prompt template includes a constraint section specifying that the natural language recommendation data is to be generated based on developmental appropriateness criteria derived from the analysis result data.

12. The system of claim 1, wherein associating the natural language recommendation data with candidate content information comprises applying a semantic matching algorithm that computes similarity scores between tokens extracted from the natural language recommendation data and attribute values of candidate content items stored in the storage device.

13. The system of claim 12, wherein candidate content items with similarity scores above a predefined threshold are included in the report data, ranked by similarity score in descending order.

14. The system of claim 1, wherein updating the learning model comprises applying a stochastic gradient descent algorithm or an adaptive learning rate algorithm to update model parameters using the operation history data as a supervised training signal.

15. The system of claim 14, wherein the operation history data comprises labels derived from operations performed by the user, including at least one of a selection operation, a viewing duration, and an engagement metric, and wherein the labels are used as target values in the supervised training.

16. The system of claim 5, wherein performing time-series analysis comprises applying at least one of a moving average algorithm, an exponential smoothing algorithm, or a recurrent neural network to past structured data ordered by timestamp to compute trend indicators for the characteristics and interest tendencies.

17. The system of claim 1, wherein the circuitry is configured to:
apply a longitudinal tracking algorithm to successive analysis result data stored in the storage device to detect developmental changes in the subject's characteristics over time and generate developmental tracking data.

18. A system comprising:
circuitry configured to:
receive structured data comprising information on behavior, interest, and activity of a subject via a communication interface;
preprocess the structured data using a natural language processing algorithm and a statistical learning algorithm to convert text information and attribute information into feature data represented as numerical vectors and calculate analysis result data indicating characteristics and interest tendencies of the subject;
generate prompt generation data by constructing a prompt sentence comprising age, target of interest, behavior history, and activity history of the subject according to a template generation algorithm, and transmit the prompt generation data to a generative artificial intelligence model to obtain natural language recommendation data;
associate the natural language recommendation data with candidate content information to generate report data and output the report data to the terminal device; and
apply an emotion recognition algorithm to determine an emotional state and adjust at least one of the prompt sentence and the natural language recommendation data based on the emotional state.

19. The system of claim 18, wherein the circuitry is configured to apply a semantic matching algorithm that computes similarity scores between tokens extracted from the natural language recommendation data and attribute values of candidate content items, and to include candidate content items with similarity scores above a predefined threshold in the report data ranked by similarity score.

20. A method performed by circuitry, the method comprising:
receiving structured data comprising information on behavior, interest, and activity of a subject via a communication interface;
preprocessing the structured data using a natural language processing algorithm and a statistical learning algorithm to convert text information and attribute information into feature data represented as numerical vectors;
calculating analysis result data indicating characteristics and interest tendencies of the subject from the feature data;
generating prompt generation data by summarizing age, target of interest, behavior history, and activity history of the subject according to a template generation algorithm and constructing a prompt sentence comprising the summarized contents;
transmitting the prompt generation data to a generative artificial intelligence model to obtain natural language recommendation data;
associating the natural language recommendation data with candidate content information to generate report data;
applying an emotion recognition algorithm to determine an emotional state and adjusting at least one of the prompt sentence and the natural language recommendation data based on the emotional state; and
receiving operation history data from a terminal device and updating a learning model using the operation history data.
